(19) United States
(12) Patent Application Publication
(10) Pub. No.: US 2024/0158928 A1
(43) Pub. Date: May 16, 2024

(54) INTEGRATED ELECTROLYTIC SYSTEM FOR CONVERTING CARBON OXIDES INTO CARBON CONTAINING PRODUCTS

(71) Applicant: Twelve Benefit Corporation, Berkeley, CA (US)

(72) Inventors: Yueshen Wu, Berkeley, CA (US); Ziyang Huo, Moraga, CA (US)

(21) Appl. No.: 18/495,406

(22) Filed: Oct. 26, 2023

Related U.S. Application Data
(60) Provisional application No. 63/381,911, filed on Nov. 1, 2022.

(51) Int. Cl. C25B 3/26; C25B 9/21; C25B 13/08; C25B 15/08

(52) U.S. Cl. CPC C25B 3/26; C25B 9/21; C25B 13/08; C25B 15/085; C25B 15/087

(57) ABSTRACT

An integrated system and method for conversion of carbon oxides to carbon containing products are disclosed. Pre-purification of a carbon oxide gas by electrodialysis, and subsequent electrochemical reduction of the purified gas with a carbon oxide electrolyzer equipped with a polymer electrolyte membrane yields carbon containing products.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

The present disclosure generally relates to the field of electrochemical reactions, and more particularly to devices and methods for electrochemically reducing carbon oxides into carbon-containing chemical compounds.

Greenhouse gas emissions such as CO₂ can have a potential impact on the climatic environment if left uncontrolled. The conversion of fossil fuels such as coal or natural gas into energy is a major source of greenhouse gas emissions. There is an urgent need for a system for more effective management of these carbon dioxide emissions. Improvements in carbon capture technology whereby a stream of low-quality and/or low-concentration gas is purified to obtain a stream of higher quality and/or higher concentration of gas are of great interest to manufacturing and energy industries where the gases are generated. Techniques which transform carbon dioxide into useful products are much sought-after. In particular, an integrated apparatus for purification of CO₂ whose efficiencies could be leveraged in a symbiotic manner with the versatility of a CO₂ electrolyzer for conversion to carbon containing products would be highly desirable.

The background description provided herein is for the purpose of generally presenting the context of the disclosure. Work of the presently named inventors, to the extent it is described in this background section, as well as aspects of the description that may not otherwise qualify as art at the time of filing, are neither expressly or impliedly admitted as prior art against the present disclosure.

### SUMMARY

An integrated system and method for conversion of carbon oxides to carbon containing products are disclosed. Pre-purification of a carbon oxide gas by electrodialysis, and subsequent electrochemical reduction of the purified gas with a carbon oxide electrolyzer equipped with a polymer electrolyte membrane yields carbon containing products.

Accordingly, in a first aspect, the present invention encompasses a system. In some embodiments, the system includes a CO₂ purifier having: (a) an inlet for receiving impure CO₂, (b) a cathode, (c) an anode, (d) a plurality of parallel liquid flow paths between the anode and the cathode, wherein the plurality of parallel liquid flow paths include (i) a carbonate donating flow path configured to flow a first solution containing carbonate and/or bicarbonate ions and bounded on its anode-facing side by an anion exchange membrane, and (ii) a carbonate receiving flow path arranged adjacent to, and on the anode side of, said carbonate donating flow path and configured to flow a second solution that is more acidic than the first solution, wherein the carbonate receiving flow path is bounded on its cathode-facing side by said anion exchange membrane that allows the carbonate and/or bicarbonate ions to pass from the carbonate donating flow path to the carbonate receiving flow path, and (e) an outlet for removing purified CO₂; and a CO₂ electrolyzer configured to receive the purified CO₂ from the CO₂ purifier, the CO₂ electrolyzer including a cathode configured to electrochemically reduce CO₂ to produce a carbon containing product.

In some embodiments, the carbonate donating flow path is bounded on its cathode-facing side by a bipolar membrane.

In some embodiments, the carbonate receiving flow path is bounded on its anode-facing side by a bipolar membrane.

In some embodiments, the plurality of parallel liquid flow paths also includes (iii) a second carbonate donating flow path configured to flow the first solution and bounded on its cathode-facing side by the bipolar membrane and bounded on its anode-facing side by a second anion exchange membrane, and (iv) a second carbonate receiving flow path arranged adjacent to, and on the anode side of, said second carbonate donating flow path and configured to flow the second solution, wherein the second carbonate receiving flow path is bounded on its cathode-facing side by said second anion exchange membrane.

In some embodiments, the second carbonate receiving flow path is bounded on its anode-facing side by a second bipolar membrane.

In some embodiments, the system also includes a first solution tank configured to supply the first solution to the carbonate donating flow path.

In some embodiments, the system also includes a recycle path configured to recycle the first solution from the carbonate donating flow path to the first solution tank.

In some embodiments, the system also includes a second solution tank configured to supply the second solution to the carbonate receiving flow path.

In some embodiments, the system also includes a recycle path configured to recycle the second solution from the carbonate receiving flow path to the second tank.

In some embodiments, the plurality of parallel liquid flow paths also includes (iii) a cation-donating flow path adjacent to the anode and bounded on its cathode-facing side by a first cation exchange membrane configured to transport cations to the first solution, and (iv) a cation-receiving flow path adjacent to the cathode and bounded on its anode-facing side by a second cation exchange membrane configured receive cations from the first solution.

In some embodiments, the CO₂ electrolyzer includes a membrane electrode assembly between an electrolyzer cathode and an electrolyzer anode.

In some embodiments, the membrane electrode assembly includes a bipolar membrane having a layer of anion conducting polymer and a layer of cation conducting polymer.

In some embodiments, the layer of anion conducting polymer faces the electrolyzer cathode and a layer of cation conducting polymer faces the electrolyzer anode.

In some embodiments, the CO₂ electrolyzer does not include liquid between the electrolyzer cathode and the electrolyzer anode.

In some embodiments, the electrolyzer cathode includes metal catalyst nanoparticles supported on carbon nanoparticles.

In some embodiments, the metal catalyst nanoparticles are gold, silver, platinum, copper or a combination thereof.

In some embodiments, the electrolyzer cathode includes an anion exchange polymer and metal catalyst nanoparticles.

In some embodiments, the CO₂ electrolyzer is directly coupled to the CO₂ purifier and configured to directly receive the purified CO₂ from the CO₂ purifier.

In some embodiments, the system also includes a controller configured to cause electrical energy to be applied to the CO₂ electrolyzer to cause the cathode to electrochemically reduce the CO₂ to produce the carbon containing product.

In some embodiments, the controller is also configured to cause electrical energy to be applied to the CO₂ purifier to cause the CO₂ purifier to produce the purified CO₂.

In some embodiments, the carbon containing product includes carbon monoxide, a hydrocarbon, formic acid, an alcohol, or any combination thereof.

In a second aspect, the present invention encompasses a method of converting carbon oxide to a carbon-containing product. In some embodiments, the method includes purifying CO₂ in a CO₂ purifier comprising an anode, a cathode, and a plurality of parallel liquid flow paths between the anode and the cathode, wherein the plurality of parallel liquid flow paths comprise: (a) a carbonate donating flow path bounded on its anode-facing side by an anion exchange membrane, and (b) a carbonate receiving flow path arranged adjacent to, and on the anode side of, said carbonate donating flow path, wherein the carbonate receiving flow path is bounded on its cathode-facing side by said anion exchange membrane, the purifying includes receiving impure CO₂; contacting the impure CO₂ with a first solution and producing carbonate and/or bicarbonate ions; flowing the first solution through the carbonate donating flow path; flowing a second solution that is more acidic than the first solution through the carbonate receiving flow path; applying a potential between the anode and cathode and causing the carbonate and/or bicarbonate ions to pass from the carbonate donating flow path to the carbonate receiving flow path; and obtaining purified CO₂ from the second solution; and electrochemically reducing the purified CO₂, the electrochemically reducing includes providing the purified CO₂ to a CO₂ electrolyzer, and electrochemically reducing the purified CO₂ at a cathode of the CO₂ electrolyzer to produce a carbon containing product.

In some embodiments, the carbonate donating flow path is bounded on its cathode-facing side by a bipolar membrane.

In some embodiments, the carbonate receiving flow path is bounded on its anode-facing side by a bipolar membrane.

In some embodiments, the method also includes flowing the first solution through a second carbonate donating flow path, wherein the second carbonate donating flow path is bounded on its cathode-facing side by the bipolar membrane and is bounded on its anode-facing side by a second anion exchange membrane; and flowing the second solution through a second carbonate receiving flow path, wherein the second carbonate receiving flow path is arranged adjacent to, and on the anode side of, said second carbonate donating flow path, and wherein the second carbonate receiving flow path is bounded on its cathode-facing side by said second anion exchange membrane.

In some embodiments, the second carbonate receiving flow path is bounded on its anode-facing side by a second bipolar membrane.

In some embodiments, the method also includes supplying the first solution from a first solution tank to the carbonate donating flow path.

In some embodiments, the method also includes recycling the first solution from the carbonate donating flow path to the first solution tank.

In some embodiments, the method also includes supplying the second solution from a second solution tank to the carbonate receiving flow path.

In some embodiments, the method also includes recycling the second solution from the carbonate receiving flow path to the second solution tank.

In some embodiments, the method also includes flowing a cation-donating solution through a cation-donating flow path to transport cations to the first solution, wherein the cation-donating flow path is adjacent to the anode and bounded on its cathode-facing side by a first cation exchange membrane; and flowing a cation-receiving solution through a cation-receiving flow path to receive cations from the first solution, wherein the cation-receiving flow path is adjacent to the cathode and bounded on its anode-facing side by a second cation exchange membrane.

In some embodiments, the second solution comprises a pH buffer.

In some embodiments, the pH buffer is an acid phosphate.

In some embodiments, the CO₂ electrolyzer includes a membrane electrode assembly between an electrolyzer cathode and an electrolyzer anode.

In some embodiments, the membrane electrode assembly includes a bipolar membrane having a layer of anion conducting polymer and a layer of cation conducting polymer.

In some embodiments, the layer of anion conducting polymer faces the electrolyzer cathode and a layer of cation conducting polymer faces the electrolyzer anode.

In some embodiments, the CO₂ electrolyzer does not include liquid between the electrolyzer cathode and the electrolyzer anode.

In some embodiments, the electrolyzer cathode includes metal catalyst nanoparticles supported on carbon nanoparticles.

In some embodiments, the metal catalyst nanoparticles are gold, silver, platinum, copper or a combination thereof.

In some embodiments, the electrolyzer cathode includes an anion exchange polymer and metal catalyst nanoparticles.

In some embodiments, the method also includes directly transporting the purified CO₂ from the CO₂ purifier to an inlet of the CO₂ electrolyzer.

In some embodiments, the carbon containing product is carbon monoxide, a hydrocarbon, formic acid, an alcohol, or a combination thereof.

These and other aspects are described further below with reference to the drawings.

### BRIEF DESCRIPTION OF THE DRAWINGS

FIG. 1 is a block diagram illustrating a system employing a CO₂ purifier and a CO₂ electrolyzer in accordance with certain disclosed embodiments.

FIG. 2 is a depiction of a CO₂ purifier integrated with a CO₂ electrolyzer in accordance with certain disclosed embodiments.

FIG. 3 is a depiction of an alternative configuration of a CO₂ electrolyzer integrated with a CO₂ purifier in accordance with certain disclosed embodiments.

FIG. 4 is a depiction of a CO₂ purifier in accordance with certain disclosed embodiments.

FIG. 5 is a block diagram schematically illustrating an exemplary electrolyzer for carbon oxide reduction that may include a cell comprising an MEA (membrane electrode assembly) in accordance with certain disclosed embodiments.

FIG. 6 depicts an example MEA for use in carbon oxide (COₓ) reduction. The MEA has a cathode layer and an anode layer separated by an ion-conducting polymer layer in accordance with certain disclosed embodiments.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

### Definitions

As used herein, the term “about” is understood to account for minor increases and/or decreases beyond a recited value, which changes do not significantly impact the desired function the parameter beyond the recited value(s). In some cases, “about” encompasses+/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

An “electrochemical cell” includes electrolyzers such as CO₂ electrolyzers and water electrolyzers. It also includes some forms of CO₂ purifiers, particularly those that employ faradaic reactions at an anode and/or a cathode.

A “carbon oxide” (COₓ) includes carbon dioxide (CO₂), carbon monoxide (CO), carbonate ions (CO₃²⁻), bicarbonate ions (HCO₃⁻), and any combinations thereof.

A “mixture” contains two or more components and unless otherwise stated may contain components other than the identified components.

A “CO₂ purifier” is a device configured to purify CO₂ from an impure CO₂ source or feed stream. There are various types of CO₂ purifier that employ various operating principles. Some purifiers rely on a CO₂ sorbent that selectively binds to CO₂ under a first condition and releases purified CO₂ under second condition. Because of its function, a CO₂ purifier is sometimes referred to as a CO₂ separator or as a CO₂ scrubber. Some systems employ one or more CO₂ purifiers integrated with one or more CO₂ electrolyzers.

“Electrodialysis” is a separation process in which charged membranes and electrical potential differences are used to separate ionic species from an aqueous solutions and other uncharged components.

CO₂ Electrolyzer/CO₂ Purifier Integration

Aspects of this disclosure relate to a CO₂ purifier and integration of a CO₂ purifier with a CO₂ electrolyzer. In operation, the CO₂ purifier selectively concentrates CO₂ present in an inlet source. The CO₂ purifier accomplishes this by selectively capturing CO₂ from a gas stream and then releasing purified CO₂ as an output. The purified CO₂ is then provided as an input to the cathode of the CO₂ electrolyzer. The CO₂ electrolyzer can electrochemically reduce the CO₂ to a carbon-containing product (CCP) that may be stored, consumed, and/or used to synthesize a valuable product.

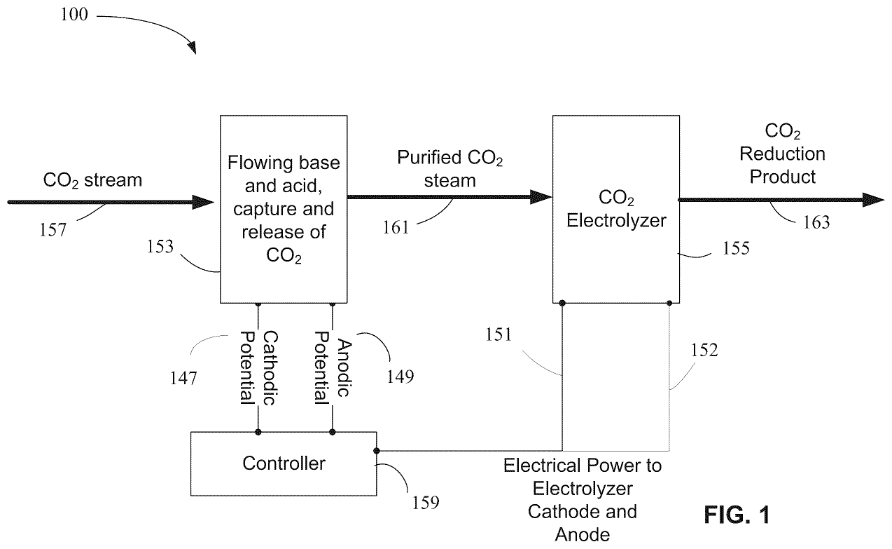

The FIG. 1 block diagram depicts an overview of a system 100 employing a CO₂ purifier integrated with a CO₂ electrolyzer in accordance with certain disclosed embodiments. Carbon dioxide 157 may be sourced from the atmosphere (air), steam, or power plant flue gas emissions among others. In system 100, a carbon dioxide gas stream is fed into an electrodialysis unit 153 (a CO₂ purifier), which is configured to take in an impure CO₂ stream 157 and convert it to purified CO₂ 161. The purified carbon dioxide 161 is then fed into an electrolyzer 155 to a produce reduction product 163. A controller 159 is operably linked to electrodialysis unit 153 and electrolyzer 155 to coordinate processing. Controller 159 may include a power supply that controls the electrical potential and/or current provided to electrodialysis unit 153 and CO₂ electrolyzer 155. As illustrated, controller 159 provides an anodic potential 149 and a cathodic potential 147 to facilitate CO₂ capture and release in electrodialysis unit 153. Controller 159 also regulates power supplied to electrolyzer 155 by providing anodic and cathodic electrical potential or current (151 and 152) to the anode and cathode of the electrolyzer. Controller 159 may comprise a mass flow controller in some embodiments. The controller feedback loop may include one or more measuring devices such as pressure, pH and conductivity meters with sensors at various outlet points of the system attached to a computing device. Integration of a CO₂ electrolyzer and a CO₂ purifier is advantageous in terms of a smaller footprint and lower capital costs, as two pieces of equipment can be combined into a single stack in some embodiments.

A carbon dioxide electrolyzer of the disclosure may be directly connected (e.g., via the cathode flow field and/or gas diffusion layer) to a downstream system, and/or the carbon dioxide reactor output may be connected to a purification system; a gas compression system; or both a purification system and a gas compression system, in either order; which then optionally connect to an input of a downstream system and/or to one or more storage devices. Multiple purification systems and/or gas compression systems may be employed. In various embodiments, a carbon-containing product and/or oxygen produced by a carbon oxide electrolyzer is provided to a storage vessel for the carbon-containing product and/or a storage vessel for the oxygen.

A CO₂ electrolyzer integrated with a CO₂ purifier may be configured, designed, and/or controlled in a manner that allows the electrolyzer to produce one or more carbon dioxide electrolysis products in a quantity, concentration, and/or ratio suitable for any of various downstream processes such as producing valuable carbon-containing products such as plastics and/or producing fuels such as syngas or naphtha. In certain embodiments, a CO₂ electrolyzer is configured to produce a hydrocarbon such as methane or ethene which may be combusted and/or utilized by fuel-cell to generate electrical energy. In certain embodiments, the integrated CO₂ electrolyzer and CO₂ purifier are scalable, and may even be of a sufficiently small size to be portable.

Different CO₂ electrolyzers (e.g., including different layer stacks, catalysts and/or catalyst layers, PEMs, flow fields, gas diffusion layers, cell compression configurations, and/or any other suitable aspects, etc.) can be used to produce different reduction products; however, different reduction products can additionally or alternatively be produced by adjusting the operation parameters, and/or be otherwise achieved.

An integrated CO₂ purifier and electrolyzer system may include a connection between a CO₂ containing output of a device such as an energy conversion device (e.g., a combustion turbine or fuel cell) and an input of a CO₂ purifier. The CO₂ containing output of such device may be connected to a gas compression system and/or other system, which then connects to an input of a CO₂ purifier of the disclosure. Multiple CO₂ generating devices and/or gas compression systems may be connected to a CO₂ purifier. The carbon dioxide containing output may be stored in a storage vessel.

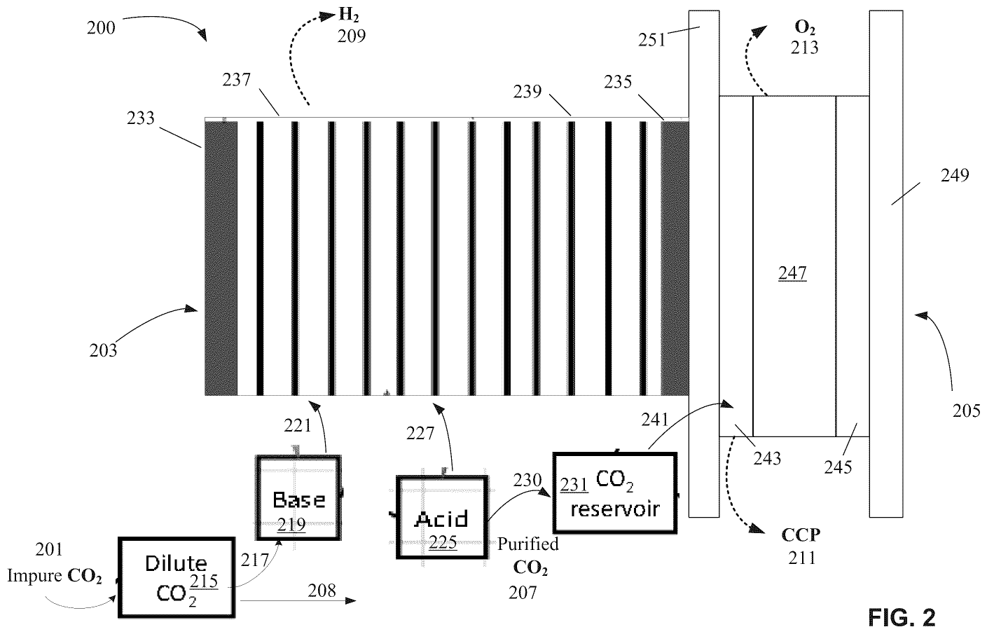

FIG. 2 is an illustration of a purifier integrated with a CO₂ electrolyzer in accordance with certain disclosed embodiments. System 200 is configured to input impure carbon dioxide 201 into an exemplary CO₂ purifier, electrodialysis unit 203. Electrodialysis unit 203 is connected in line and before CO₂ electrolyzer 205 in certain embodiments. Electrodialysis unit 203 produces purified carbon dioxide 207, a CO₂-depleted stream 208, and optionally hydrogen 209. The purified carbon dioxide 207 from electrodialysis unit 203 is fed into CO₂ electrolyzer 205, which converts purified carbon dioxide 207 into carbon containing products 211 at a cathode 243. Electrolyzer 205 also converts water to oxygen 213 at an anode 245.

Electrodialysis unit 203 purifies carbon dioxide by utilizing ion exchange membranes and electrical potential differences to move ionic species (notably carbonate and/or bicarbonate ions) from a basic aqueous solution across anion exchange membranes to an acidic aqueous solution. System 200 may be configured to produce purified by CO₂ as follows. Impure CO₂ 201 is optionally provided to a reservoir 215. Reservoir 215 stores CO₂ in a gas phase. When the CO₂ goes into the base tank it will be captured by the KOH. In some embodiments, the CO₂ may be pumped in at a flow rate of from about 10 to about 50,000 l/hr.

Impure CO₂ gas 201 is delivered to a first solution tank 219 from reservoir 215 via a flow path 217. The pressure in flow path 217 may be from about 1 to 10 atmospheres. In some implementations, a reservoir is not employed, and CO₂ is fed directly to from impure CO₂ stream 201 to the basic solution in tank 219. Solution tank 219 contains a basic solution, which may contain a salt. The first solution tank 219 is optionally agitated. Impure CO₂ 201 reacts with the basic salt solution to form carbonate or bicarbonate anions. The carbonate or bicarbonate anions are fed into electrodialysis unit 203 via flow path 221.

Electrodialysis unit 203 includes an anode 233, a cathode 235, a plurality of ion exchange membranes 239 (bipolar, cation exchange and anion exchange) and flow paths 237. The flow paths are bounded by the ion exchange membranes. Some of the flow paths transport the basic solution containing carbonate and/or bicarbonate ions. In certain embodiments, the basic solution is recycled to the first solution tank 219.

A second solution tank 225 contains an acidic solution. The acidic solution from the second solution tank 225 is delivered to the electrodialysis unit 203 via flow path 227. In the electrodialysis unit, the acidic solution flows in one or more flow paths 237. After flowing through these paths, the acidic solution may be recycled back to tank 225. By applying a potential between anode 233 and cathode 235, which crosses the flow paths 237, the system 200 causes ions to be transported across membranes 239. In particular, carbonate and/or bicarbonate ions in one or more basic solution flow paths pass across anion conducting membranes where they are received by the acidic solution flowing in parallel flow paths. When the acidic solution is recycled to second solution tank 225 it brings along free CO₂. This is because, in acidic solution, the carbonate and/or bicarbonate ions are converted into purified carbon dioxide gas 207 and recovered from the gas headspace of the second solution tank 225.

Purified CO₂ is transported from the second solution tank 225 via flow path 230 into CO₂ reservoir 231.

The CO₂ electrolyzer 205 receives purified CO₂ 207 from CO₂ reservoir 231 via path 241. The CO₂ electrolyzer 205 comprises anode current collector 249, a cathode current collector 251, and a membrane electrode assembly (MEA) comprising an anode 245, a separator membrane 247, and a cathode 243. Purified CO₂ 207 is fed into electrolyzer 205 where it is electrochemically reduced at cathode 243 and converted into carbon containing products 211. Water (not shown) is fed to anode 245, where it is oxidized to produce oxygen 213.

Cathode 235 and anode 233 of the electrodialysis unit are equivalent to a water electrolyzer, which can electrolyze water into hydrogen and oxygen.

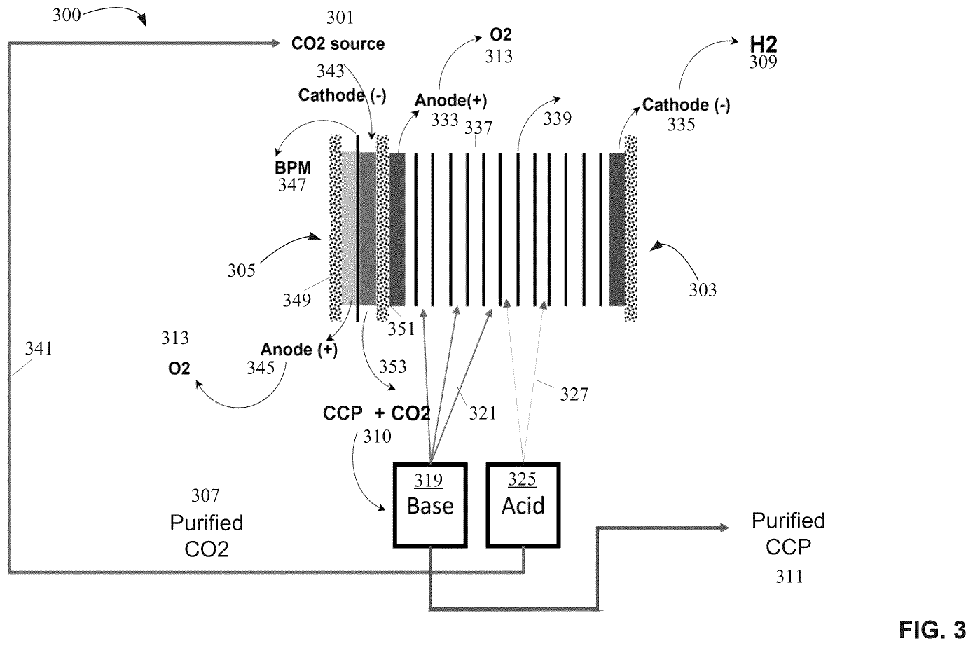

FIG. 3 is an illustration of an alternative configuration for a purifier integrated with a CO₂ electrolyzer from that illustrated in FIG. 2, in accordance with certain disclosed embodiments. In this configuration, the system 300 can operate as a product gas purifier as well as a CO₂ recycling device. System 300 is configured to input impure carbon dioxide as well as processed CO₂ collected from electrodialysis unit 303 at source 301 into an exemplary CO₂ electrolyzer 305.

The CO₂ electrolyzer 305 comprises anode current collector 349, a cathode current collector 351, and a membrane electrode assembly (MEA) comprising an anode 345, a separator membrane 347, and a cathode 343. CO₂ from source 301 is fed into electrolyzer 305 where it is electrochemically reduced at cathode 343 and converted into gaseous carbon containing products such as carbon monoxide, methane and ethylene and/or CO₂ (collectively 310, the output of the CO₂ electrolyzer which in some embodiments is a mixture of products). Water (not shown) is fed to anode 345, where it is oxidized to produce oxygen 313.

The output 310 of CO₂ electrolyzer 305 may be fed into an exemplary CO₂ purifier, electrodialysis unit 303 via path 353. Output 310 may include carbon monoxide as a carbon-containing product along with CO₂. When output 310 is passed through base tank 319, CO₂ is absorbed, leaving carbon monoxide in the gas phase. As such, the carbon monoxide is not directly fed into the electrodialysis unit 303. Electrodialysis unit 303 is connected in line and after CO₂ electrolyzer 305 in certain embodiments. Electrodialysis unit 303 produces purified carbon-containing products 311 (such as carbon monoxide), carbon dioxide and optionally hydrogen 309. The purified carbon dioxide 307 from electrodialysis unit 303 may be recycled back into CO₂ electrolyzer 305 via path 341. Electrolyzer 305 also converts water to oxygen 313 at an anode 345.

Electrodialysis unit 303 purifies carbon dioxide by utilizing ion exchange membranes and electrical potential differences to move ionic species (notably carbonate and/or bicarbonate ions) from a basic aqueous solution across anion exchange membranes to an acidic aqueous solution. System 300 may be configured to produce purified CO₂ 307 and/or purified carbon containing products 311 such as CO as follows. CO₂ from electrolyzer 305 is optionally provided to a reservoir (not shown). The reservoir may store CO₂ in a gas phase. When the CO₂ goes into the base tank it will be captured by the KOH. In some embodiments, the CO₂ may be pumped in at a flow rate of from about 10 to about 50,000 l/hr.

In some implementations, a reservoir is not employed, and mixture 310 of carbon-containing products and CO₂ from the electrolyzer are fed directly to the basic solution in tank 319. Solution tank 319 contains a basic solution, which may contain a salt. The first solution tank 319 is optionally agitated. CO₂ reacts with the basic salt solution to form carbonate or bicarbonate anions. The carbonate or bicarbonate anions are fed into electrodialysis unit 303 via flow path 321.

Electrodialysis unit 303 includes an anode 333, a cathode 335, a plurality of ion exchange membranes 339 (bipolar, cation exchange and anion exchange) and flow paths 337. The flow paths are bounded by the ion exchange membranes. Some of the flow paths transport the basic solution containing carbonate and/or bicarbonate ions. In certain embodiments, the basic solution is recycled to the first solution tank 319.

A second solution tank 325 contains an acidic solution. The acidic solution from the second solution tank 325 is delivered to the electrodialysis unit 303 via flow path 327. In the electrodialysis unit, the acidic solution flows in one or more flow paths 337. After flowing through these paths, the acidic solution may be recycled back to tank 325. By applying a potential between anode 333 and cathode 335, which crosses the flow paths 337, the system 300 causes ions to be transported across membranes 339. In particular, carbonate and/or bicarbonate ions in one or more basic solution flow paths pass across anion conducting membranes where they are received by the acidic solution flowing in parallel flow paths. When the acidic solution is recycled to second solution tank 325 it brings along free CO₂. This is because, in acidic solution, the carbonate and/or bicarbonate ions are converted into purified carbon dioxide gas and recovered from the gas headspace of the second solution tank 325.

Purified CO₂ 307 may be recycled back to the electrolyzer 305 to constitute a portion of CO₂ source 301 via path 341.

Other configurations of the combination of electrolyzer and electrodialysis unit are envisaged in this disclosure. In some embodiments, an electrodialysis unit may be bounded on either side by an electrolyzer; or an electrolyzer may be bounded on either side by an electrodialysis unit. In some embodiments, a single combination of electrolyzer and electrodialysis unit may be integrated, while in other embodiments a series of electrolyzers and electrodialysis units may be utilized.

### CO₂ Purifier

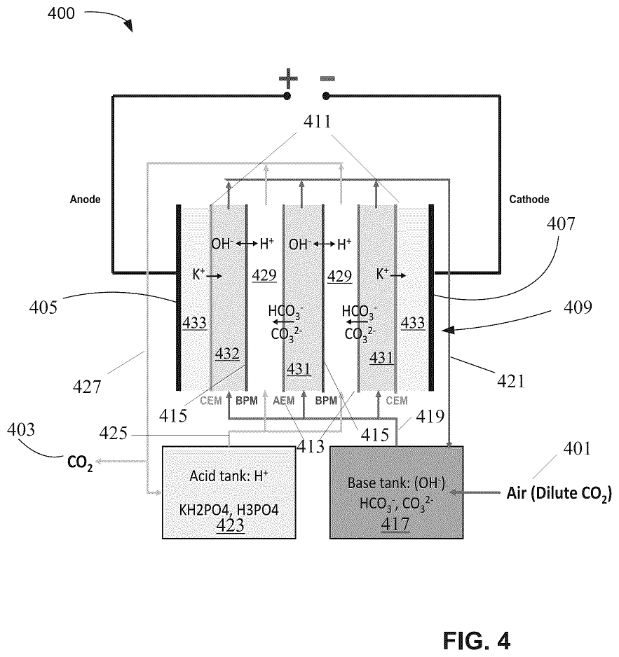

FIG. 4 illustrates the CO₂ purifier system 400 in greater detail, in accordance with certain embodiments. The input for system 400 is dilute or impure CO₂ stream 401 such as air.

A carbon dioxide purifier may receive impure CO₂ that originates from any of various sources. Examples include air or other ambient gas, combustion output gases, and factory output such as output from a cement plant or a steelmaking plant. Combustion may occur in, for example, a turbine, engine, or other device that may be provided in stationary structure (e.g., a powerplant) or a mobile structure (e.g., a transportation vehicle). In certain embodiments, impure CO₂ is from tailpipe exhaust. Typically, though not necessarily, the CO₂ is provided to purifier in gaseous form.

A source of CO₂ may be connected directly to an input of a CO₂ purifier. In some embodiments, the CO₂ is provided to a purifier after being compressed by, e.g., a gas compression system. In some embodiments, CO₂ provided to a CO₂ purifier may be recycled from a chemical reaction of a carbon-containing product of the CO₂ electrolyzer.

The CO₂ provided as input to a carbon dioxide purifier integrated with a carbon dioxide electrolyzer may have a range of concentrations. In certain embodiments, carbon dioxide provided to a carbon dioxide purifier has a concentration of about 20% or less, or about 0.01% to about 70% by volume or molar. In certain embodiments, carbon dioxide provided to a carbon dioxide purifier has a concentration of about 0.04% to about 70% by volume or molar. The CO₂ provided as input to a CO₂ purifier integrated with a CO₂ electrolyzer may be or comprise air.

Returning to FIG. 4, the system 400 has an electrodialysis stack 409 which is composed of cells. Each cell includes different membranes which alternate in parallel and at least two different solution flow paths running between the membranes. The membranes are cation exchange membranes 411, bipolar membranes 415 and anion exchange membranes 413; and the two different solution flow paths include carbonate receiving flow paths 429 for acidic solutions and carbonate donating flow paths 431 for basic solutions. Some of the basic solution runs through carbonate donating flow paths 431, each disposed separated from an acidic carbonate receiving paths 429 by anion exchange membranes 413. The rest of the basic solution runs through a carbonate flow path 432 disposed between a bipolar membrane 415 and a cation exchange membrane 411. Flow path 432 accepts positive ions moving away from a positive electrode under the influence of the electric field within electrodialysis stack 409. The acidic solution runs through the carbonate receiving flow paths 429 disposed adjacent to carbonate donating flow paths 431 but separated therefrom by anion exchange membranes 413.

Stack 409 includes at least one pair of a carbonate donating cell and a carbonate receiving cell. However, a stack may contain numerous pairs of cells in some embodiments.

The stack 409 includes cation exchange membranes (CEM) 411 at either end of the series of cells; one on the cathode 407-facing side and one on the anode 405-facing side. The cation exchange membranes 411 are parallel to each electrode, and flow paths 433 run between the CEM and the electrode at each end of the stack. Electrode solution runs through flow paths 433. In some embodiments, the electrode solution is from about 0.1 to about 5 M KOH.

The electrode solution is pumped from one electrode solution reservoir (not shown) into electrodialysis stack 409 at both the cathode 407 and anode 405 ends, flowed across the electrodes at each end, and then flowed back out of stack 409 and into a second electrode solution reservoir (not shown).

Dilute carbon dioxide 401 is fed through an inlet and bubbled into a first solution tank 417. First solution tank 417 holds a basic solution including carbonate (CO₃²⁻) and/or bicarbonate ions (HCO₃⁻), and a caustic substance and may optionally be agitated, heated or pressurized. In some embodiments, the pH of the basic solution is from about 8 to about 14. The carbon dioxide from feed 401 reacts with hydroxide ions (OH⁻) present in the basic solution to produce the CO₃²⁻ and/or HCO₃⁻. Caustic substances such as potassium hydroxide (KOH) or sodium hydroxide (NaOH) may be utilized to form the basic aqueous solution. In some embodiments, first solution tank 417 holds a solution of KHCO₃, NaHCO₃, K₂CO₃, Na₂CO₃, NaOH or KOH in a concentration range of from about 0.1M to about 5M. The pH of the solution may be monitored, and basic salt solution may be replenished as needed.

Purifier system 400 also has a second solution tank 423. Second solution tank 423 holds an acidic solution including at least one acid that may be agitated, heated or pressurized. Suitable acids include sodium or potassium phosphates. In some embodiments, the acid may be a mixture of potassium dihydrogen phosphate (KH₂PO₄) and phosphoric acid (H₃PO₄) in a concentration range of from about 0.1M to about 5M.

The acidic solution from the second solution tank 423 is conveyed to the carbonate receiving flow paths 429 via conduit 425. Recycle flow path 427 returns solution from the stack 409 to the second solution tank 423.

The basic solution is transported via conduit 419 to carbonate donating flow paths 431. Recycle flow path 421 returns solution from the stack 409 to the first solution tank 417.

Purifier system 400 operates by driving carbonate/bicarbonate ions from basic solution in flow channels 431 to acidic solution in flow channels 429. The ions are driven by application of voltage across an alternating stack of ion-selective anion-exchange membranes and bipolar membranes and thereby moving carbon dioxide from impure carbon dioxide 401 into an acidic solution as HCO₃⁻ ions or CO₃⁻² ions. The movement of ions across the various membranes and into the various flow paths is indicated in FIG. 4. The acidic solution converts the transported CO₃⁻² or HCO₃⁻ into a resultant CO₂ gas 403 which is purer and/or more concentrated than carbon dioxide of input stream 401.

In certain embodiments, purified CO₂ output from a purifier 403 has a concentration of at least about 20 volume or mole percent, or at least about 40 volume or mole percent, or at least about 75 volume or mole percent, or at least about 90 volume or mole percent. In certain embodiments, carbon dioxide provided to a carbon dioxide reduction reactor has a concentration of about 40 to 60 volume or mole percent. As explained, the purified CO₂ may be provided to a CO₂ electrolyzer in an integrated system such as depicted in FIG. 1 or FIG. 2.

### CO₂ Electrolyzer

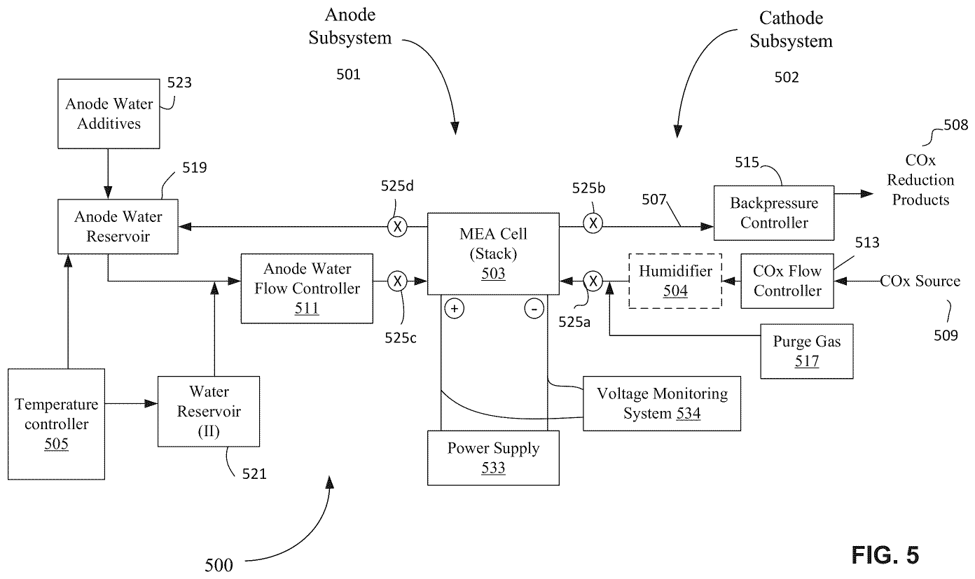

FIG. 5 depicts an example system 500 for a carbon oxide reduction reactor 503 (often referred to as an electrolyzer herein) that may include a cell comprising a MEA (membrane electrode assembly). The reactor may contain multiple cells or MEAs arranged in a stack. System 500 includes an anode subsystem 501 that interfaces with an anode of reduction reactor 503 and a cathode subsystem 502 that interfaces with a cathode of reduction reactor 503. System 500 is an example of a system that may be used with or to implement any of the methods or operating conditions described above.

As depicted, the cathode subsystem includes a carbon oxide source 509 configured to provide a feed stream of carbon oxide to the cathode of reduction reactor 503, which, during operation, may generate an output stream that includes product(s) of a reduction reaction at the cathode. The product stream may also include unreacted carbon oxide and/or hydrogen. See 508.

The carbon oxide source 509 is coupled to a carbon oxide flow controller 513 configured to control the volumetric or mass flow rate of carbon oxide to reduction reactor 503. One or more other components may be disposed on a flow path from flow carbon oxide source 509 to the cathode of reduction reactor 503. For example, an optional humidifier 504 may be provided on the path and configured to humidify the carbon oxide feed stream. Humidified carbon oxide may moisten one or more polymer layers of an MEA and thereby avoid drying such layers. Another component that may be disposed on the flow path is a purge gas inlet coupled to a purge gas source 517. In certain embodiments, purge gas source 517 is configured to provide purge gas during periods when current is paused to the cell(s) of reduction reactor 503. In some implementations, flowing a purge gas over an MEA cathode facilitates recovery of catalyst activity and/or selectivity. Examples of purge gases include carbon dioxide, carbon monoxide, hydrogen, nitrogen, argon, helium, oxygen, and mixtures of any two or more of these.

In various embodiments, a CO₂ purifier (not shown in FIG. 5) as described herein is provided upstream of source 509. Such CO₂ purifier may be considered to be part of the cathode subsystem.

During operation, the output stream from the cathode flows via a conduit 507 that connects to a backpressure controller 515 configured to maintain pressure at the cathode side of the cell within a defined range (e.g., about 50 to 800 psig, depending on the system configuration). The output stream may provide the reduction products 508 to one or more components (not shown) for separation and/or concentration.

In certain embodiments, the cathode subsystem is configured to controllably recycle unreacted carbon oxide from the outlet stream back to the cathode of reduction reactor 403. In some implementations, the output stream is processed to remove reduction product(s) and/or hydrogen before recycling the carbon oxide. Depending upon the MEA configuration and operating parameters, the reduction product(s) may be carbon monoxide, hydrogen, hydrocarbons such as methane and/or ethylene, oxygen-containing organic compounds such as formic acid, acetic acid, and any combinations thereof. In certain embodiments, one or more components, not shown, for removing water from the product stream are disposed downstream form the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon oxide from source 509 upstream of the cathode. Not shown in FIG. 5 are one or more optional separation components that may be provided on the path of the cathode outlet stream and configured to concentrate, separate, and/or store the reduction product from the reduction product stream.

As depicted in FIG. 5, an anode subsystem is configured to provide an anode feed stream to an anode side of the carbon oxide reduction reactor 503. In certain embodiments, the anode subsystem includes an anode water source, not shown, configured to provide fresh anode water to a recirculation loop that includes an anode water reservoir 519 and an anode water flow controller 511. The anode water flow controller 511 is configured to control the flow rate of anode water to or from the anode of reduction reactor 503. In the depicted embodiment, the anode water recirculation loop is coupled to components for adjusting the composition of the anode water. These may include a water reservoir 521 and/or an anode water additives source 523. Water reservoir 521 is configured to supply water having a composition that is different from that in anode water reservoir 519 (and circulating in the anode water recirculation loop). In one example, the water in water reservoir 521 is pure water that can dilute solutes or other components in the circulating anode water. Pure water may be conventional deionized water even ultrapure water having a resistivity of, e.g., at least about 15 MOhm-cm or over 18.0 MOhm-cm. Anode water additives source 523 is configured to supply solutes such as salts and/or other components to the circulating anode water.

During operation, the anode subsystem may provide water or other reactant to the anode of reactor 403, where it at least partially reacts to produce an oxidation product such as oxygen. The product along with unreacted anode feed material is provided in a reduction reactor outlet stream. Not shown in FIG. 5 are one or more optional separation components that may be provided on the path of the anode outlet stream and configured to concentrate, separate, and/or store the oxidation product from the anode product stream.

Other control features may be included in system 500. For example, a temperature controller may be configured to heat and/or cool the carbon oxide reduction reactor 503 at appropriate points during its operation. In the depicted embodiment, a temperature controller 505 is configured to heat and/or cool anode water provided to the anode water recirculation loop. For example, the temperature controller 505 may include or be coupled to a heater and/or cooler that may heat or cool water in anode water reservoir 519 and/or water in reservoir 521. In some embodiments, system 500 includes a temperature controller configured to directly heat and/or cool a component other than an anode water component. Examples of such other components in the cell or stack and the carbon oxide flowing to the cathode.

In certain embodiments, system 500 is configured to adjust the flow rate of carbon oxide to the cathode and/or the flow rate of anode feed material to the anode of reactor 503. Components that may be controlled for this purpose may include carbon oxide flow controller 513 and anode water controller 511.

Certain components of system 500 may operate to control the composition of the carbon oxide feed stream and/or the anode feed stream. For example, water reservoir 521 and/or anode water additives source 523 may be controlled to adjust the composition of the anode feed stream. In some cases, additives source 523 may be configured to adjust the concentration of one or more solutes such as one or more salts in an aqueous anode feed stream.

In some cases, a temperature controller such controller 505 is configured to adjust the temperature of one or more components of system 500 based on a phase of operation. For example, the temperature of cell 503 may be increased or decreased during break-in, a current pause in normal operation, and/or storage.

In some embodiments, a carbon oxide electrolytic reduction system is configured to facilitate removal of a reduction cell from other system components. This may be useful with the cell needs to be removed for storage, maintenance, refurbishment, etc. In the depicted embodiments, isolation valves 525a and 525b are configured to block fluidic communication of cell 503 to a source of carbon oxide to the cathode and backpressure controller 515, respectively. Additionally, isolation valves 525c and 525d are configured to block fluidic communication of cell 503 to anode water inlet and outlet, respectively.

The carbon oxide reduction reactor 503 may also operate under the control of one or more electrical power sources and associated controllers. See block 533. Electrical power source and controller 533 may be programmed or otherwise configured to control current supplied to and/or to control voltage applied to the electrodes in reduction reactor 503. Any of the current profiles described herein may be programmed into power source and controller 533.

In certain embodiments, electric power source and controller 533 performs some but not all the operations necessary to implement control profiles of the carbon oxide reduction reactor 503. A system operator or other responsible individual may act in conjunction with electrical power source and controller 533 to fully define the schedules and/or profiles of current applied to reduction reactor 503. In certain embodiments, electric power source and controller 533 controls operation of a carbon oxide purifier disposed upstream of carbon oxide source 509.

In certain embodiments, the electrical power source and controller acts in concert with one or more other controllers or control mechanisms associated with other components of system 500. For example, electrical power source and controller 533 may act in concert with controllers for controlling the purification of carbon oxide, the delivery of carbon oxide to the cathode, the delivery of anode water to the anode, the addition of pure water or additives to the anode water, and any combination of these features. In some implementations, one or more controllers are configured to control or operate in concert to control any combination of the following functions: applying current and/or voltage to reduction cell 503, controlling backpressure (e.g., via backpressure controller 515), supplying purge gas (e.g., using purge gas component 517), delivering carbon oxide (e.g., via carbon oxide flow controller 513), humidifying carbon oxide in a cathode feed stream (e.g., via humidifier 504), flow of anode water to and/or from the anode (e.g., via anode water flow controller 511), and anode water composition (e.g., via anode water source 505, pure water reservoir 521, and/or anode water additives component 523).

In the depicted embodiment, a voltage monitoring system 534 is employed to determine the voltage across an anode and cathode of an MEA cell or across any two electrodes of a cell stack, e.g., determining the voltage across all cells in a multi-cell stack. In certain embodiments, voltage monitoring system 534 is configured to work in concert with power supply 533 to cause reduction cell 503 to remain within a specified voltage range. If, for example the cell's voltage deviates from a defined range (as determined by voltage monitoring system 534), power supply may be configured to apply current or voltage to the electrodes to maintain the cell voltage within the specified range.

An electrolytic carbon oxide reduction system such as that depicted in FIG. 5 may employ a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode water, pure water, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide to the cathode inlet, humidifying carbon oxide in a cathode feed stream, flowing anode water to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and dosing of purified water and/or salt solution. These controlled processes may be connected to or interfaced with one or more systems that work in concert with the electrolytic carbon oxide reduction system.

A controller may include any number of processors and/or memory devices. The controller may contain control logic such software or firmware and/or may execute instructions provided from another source. In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g., a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

Controllers and any of various associated computational elements including processors, memory, instructions, routines, models, or other components are sometimes described or claimed as “configured to” perform a task or tasks. In such contexts, the phrase “configured to” is used to denote structure by indicating that the component includes structure (e.g., stored instructions, circuitry, etc.) that performs a task or tasks during operation. As such, a controller and/or associated component can be said to be configured to perform the task even when the specified component is not necessarily currently operational (e.g., is not on).

Controllers and other components that are “configured to” perform an operation may be implemented as hardware—for example, circuits, memory storing program instructions executable to implement the operation, etc. Additionally, controllers and other components “configured to” perform an operation may be implemented as hardware that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic.

Non-computation elements such as reactors such electrolyzers, membrane assemblies, layers, and catalyst particles may also be “configured” to perform certain functions. In such contexts, the phrase “configured to” indicate that the referenced structure has one or more features that allow the function to be performed. Examples of such features include physical and/or chemical properties such as dimensions, composition, porosity, etc.

### MEA Embodiments

MEA overview

In various embodiments, an MEA contains an anode layer, a cathode layer, electrolyte, and optionally one or more other layers. The layers may be solids and/or gels. The layers may include polymers such as ion-conducting polymers.

When in use, the cathode of an MEA promotes electrochemical reduction of COₓ by combining three inputs: COₓ, ions (e.g., protons or hydroxide ions) that chemically react with COₓ, and electrons. The reduction reaction may produce CO, hydrocarbons, and/or hydrogen and oxygen-containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

During operation of an MEA, ions move between an anode and a cathode, through one or more ion conducting layers, sometimes called a polymer-electrolyte, while electrons flow from the anode, through an external circuit, and to the cathode. In some embodiments, liquids and/or gas move through or permeates the MEA layers. This process may be facilitated by pores in the MEA.

The compositions and arrangements of layers in the MEA may promote high yield of a COₓ reduction products. To this end, the MEA may facilitate any one or more of the following conditions: (a) minimal parasitic reduction reactions (non-COₓ reduction reactions) at the cathode; (b) low loss of COₓ reactants to the anode or elsewhere in the MEA; (c) physical integrity of the MEA during the reaction (e.g., the MEA layers remain affixed to one another); (d) prevent COₓ reduction product cross-over; (e) prevent oxidation product (e.g., O₂) cross-over; (f) a suitable environment at the cathode for the reduction reaction; (g) a pathway for desired ions to travel between cathode and anode while blocking undesired ions; and (h) low voltage operation.

### COₓ Reduction Considerations

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large surface area by comparison to MEAs used for fuel cells in automotive applications. For example, MEAs for COₓ reduction may employ electrodes having surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to the highest current density possible.

### MEA Configurations

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication, which would produce a short circuit. The cathode layer includes a reduction catalyst and, optionally, an ion-conducting polymer (sometimes called an ionomer). The cathode layer may also include an electron conductor and/or an additional ion conductor. The anode layer includes an oxidation catalyst and, optionally, an ion-conducting polymer. The anode layer may also include an electron conductor and/or an additional ion conductor. The PEM also includes an ion-conducting polymer. In certain embodiments, the MEA has a cathode buffer layer between the cathode layer and the polymer electrolyte membrane. The cathode buffer also includes an ion-conducting polymer.

The ion-conducting polymers in the PEM, the cathode, the anode, and the cathode buffer layer, if present, may each be different from one another in composition, conductivity, molecular weight, or other property. In some cases, two or more of these polymers are identical. For example, the ion-conducting polymer in the cathode and cathode buffer layer may be identical.

In certain embodiments, the MEA has an anode buffer layer between the anode layer and the polymer electrolyte membrane. The anode buffer also includes an ion-conducting polymer, which may have the same properties as any of the other ion-conducting polymers (e.g., the ion-conducting polymer in the anode). In some embodiments, the ion-conducting layer of the anode may be different from every other ion-conducting layer in the MEA.

In connection with certain MEA designs, there are three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

### Ion-Conducting Polymers for MEA Layers

The term “ion-conducting polymer” or “ionomer” is used herein to describe a polymer that conducts ions (anions and/or cations) is to say that the material is an ion-conducting material or ionomer. In certain embodiments, an MEA contains one or more ion-conducting polymers having a specific conductivity of about 1 mS/cm or greater for anions and/or cations. The term “anion-conductor” describes an ion-conducting polymer that conducts anions primarily (although there will still be some small amount of cation conduction) and has a transference number for anions greater than about 0.85 at around 100 micrometers thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at about 100 micrometers thickness. For an ion-conducting polymer that is described as conducting both anions and cations (a “cation-and-anion-conductor”), neither the anions nor the cations have a transference number greater than approximately 0.85 or less than approximately 0.15 at about 100 micrometers thickness. Examples of ion-conducting polymers of each class are provided in the below Table 1.

TABLE 1
Ion-Conducting Polymers

| Class | Description | Common Features | Examples |
|---|---|---|---|
| A. Anion- | Greater than | Positively charged | aminated tetramethyl |
| conducting | approximately 1 | functional groups | polyphenylene; |
| | mS/cm specific | are covalently | poly(ethylene-co- |
| | conductivity for | bound to the | tetrafluoroethylene)- |
| | anions, which have | polymer backbone | based quaternary |
| | a transference | | ammonium polymer; |
| | number greater | | quaternized polysulfone |
| | than approximately | | |
| | 0.85 at around 100 | | |
| | micron thickness | | |
| B. Conducts | Greater than | Salt is soluble may | polyethylene oxide; |
| both anions | approximately 1 | be the polymer and | polyethylene glycol; |
| and cations | mS/cm conductivity | the salt ions may | poly(vinylidene |
| | for ions (including | move through the | fluoride); polyurethane |
| | both cations and | polymer material | |
| | anions), which have | | |
| | a transference | | |
| | number between | | |
| | approximately 0.15 | | |
| | and 0.85 at around | | |
| | 100 micron thickness | | |
| C. Cation- | Greater than | Negatively charged | perfluorosulfonic acid |
| conducting | approximately 1 | functional groups | polytetrafluoroethylene |
| | mS/cm specific | are covalently | co-polymer; sulfonated |
| | conductivity for | bound to the | poly(ether ketone); |
| | cations, which have | polymer backbone | poly(styrene sulfonic |
| | a transference | | acid-co-maleic acid) |
| | number greater | | |
| | than approximately | | |
| | 0.85 at around 100 | | |
| | micron thickness | | |

### Ionomer Structures

Examples of polymeric structures that can include an ionizable moiety or an ionic moiety and be used as ion-conducting polymers (ionomers) in the MEAs described here are provided below. The ion-conducting polymers may be used as appropriate in any of the MEA layers. Charge conduction through the material can be controlled by the type and amount of charge (e.g., anionic and/or cationic charge on the polymeric structure) provided by the ionizable/ionic moieties. In addition, the composition can include a polymer, a homopolymer, a copolymer, a block copolymer, a polymeric blend, other polymer-based forms, or other useful combinations of repeating monomeric units. As described below, an ion conducting polymer layer may include one or more of crosslinks, linking moieties, and arylene groups according to various embodiments. In some embodiments, two or more ion conducting polymers (e.g., in two or more ion conducting polymer layers of the MEA) may be crosslinked. Ionic groups that impart ionic conductivity may be provided in groups pendant to a polymer backbone and/or ionic groups may be provided in the polymer backbone itself.

Non-limiting monomeric units can include one or more of the following:

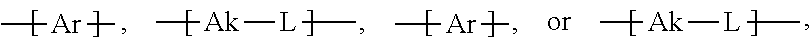

in which Ar is an optionally substituted arylene or aromatic; Ak is an optionally substituted alkylene, haloalkylene, aliphatic, heteroalkylene, or heteroaliphatic; and L is a linking moiety (e.g., any described herein) or can be —C(R⁷)(R⁸)—. Yet other non-limiting monomeric units can include optionally substituted arylene, aryleneoxy, alkylene, or combinations thereof, such as optionally substituted (aryl)(alkyl)ene (e.g., -Ak-Ar or -Ak-Ar-Ak- or —Ar-Ak-, in which Ar is an optionally substituted arylene and Ak is an optionally substituted alkylene). One or more monomeric units can be optionally substituted with one or more ionizable or ionic moieties (e.g., as described herein).

One or more monomeric units can be combined to form a polymeric unit. Non-limiting polymeric units include any of the following:

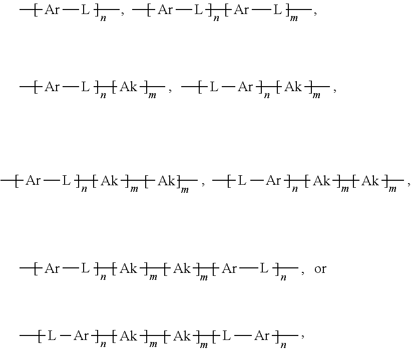

in which Ar, Ak, L, n, and m can be any described herein. In some embodiments, each m is independently 0 or an integer of 1 or more. In other embodiments, Ar can include two or more arylene or aromatic groups.

Other alternative configurations are also encompassed by the compositions herein, such as branched configurations, diblock copolymers, triblock copolymers, random or statistical copolymers, stereoblock copolymers, gradient copolymers, graft copolymers, and combinations of any blocks or regions described herein.

In some cases, alternative backbone structures are used with the electroactive moieties described herein. In some embodiments, the backbone does not include an aryl moiety. In some embodiments, the backbone does not include any aromatic moieties. In some embodiments, the backbone comprises only carbon-carbon linkages that are methylene and/or substituted methylene moieties. In some embodiments, the backbone comprises one or more styrene moieties. In an example, the backbone comprises styrene moieties, butylene moieties, and ethylene moieties, all linked via non-aromatic carbon-carbon bonds. Any of these moieties may be unsubstituted or substituted. In another example, the backbone comprises styrene moieties and conjugated or unconjugated heterocyclic groups all linked via non-aromatic carbon-carbon bonds. Any of these moieties may be unsubstituted or substituted. In all such examples, the polymer includes one or more types of pendant electroactive moiety as described herein. Further, in all examples, the polymer is optionally a copolymer. And, in all examples, the polymer is optionally crosslinked.

Examples of types of positively charged ionizable moieties include various nitrogen-containing groups and phosphonium groups. Nitrogen-containing positively charged groups may include quaternary ammonium groups, amines, guanidinium groups, and uronium groups. Some nitrogen-containing positively charged groups are present in heterocyclic ring structures. Such ring structures include both conjugated and non-conjugated heterocycles. Examples include imidazolium groups, pyridinium groups, and piperidinium groups. Examples of types of negatively charged ionizable moieties include sulfonic acid groups, acetic acid, triflourosulfonic groups, and triflouroacetic acid.

In one embodiment, the MW of the ion-conducting polymer is a weight-average molecular weight (MW) of at least 10,000 g/mol; or from about 5,000 to 2,500,000 g/mol. In another embodiment, the MW is a number average molecular weight (Mn) of at least 20,000 g/mol; or from about 2,000 to 2,500,000 g/mol.

In any embodiment herein, each of n, n1, n2, n3, n4, m, m1, m2, or m3 is, independently, 1 or more, 20 or more, 50 or more, 100 or more; as well as from 1 to 1,000,000, such as from 10 to 1,000,000, from 100 to 1,000,000, from 200 to 1,000,000, from 500 to 1,000,000, or from 1,000 to 1,000,000.

### Bipolar MEA for COx Reduction

In certain embodiments, the MEA includes a bipolar interface having an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and PEM, contains an anion-conducting polymer. In some embodiments, an anode buffer layer, located between the anode and PEM, contains a cation-conducting polymer.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas decreases and the rate of production of CO or other carbon-containing product increases.

Another reaction that may be avoided is reaction of carbonate or bicarbonate ions at the anode to produce CO₂. Aqueous carbonate or bicarbonate ions may be produced from CO₂ at the cathode. If such ions reach the anode, they may react with hydrogen ions to produce and release gaseous CO₂. The result is net movement of CO₂ from the cathode to the anode, where it does not get reduced and is lost with oxidation products. To prevent the carbonate and bicarbonate ion produced at the cathode from reaching the anode, the anode and/or an anode buffer layer may include a cation-conducting polymer, which at least partially blocks the transport of negative ions such as bicarbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂ and CO₂ reduction products (e.g., bicarbonate) to the anode side of the cell.

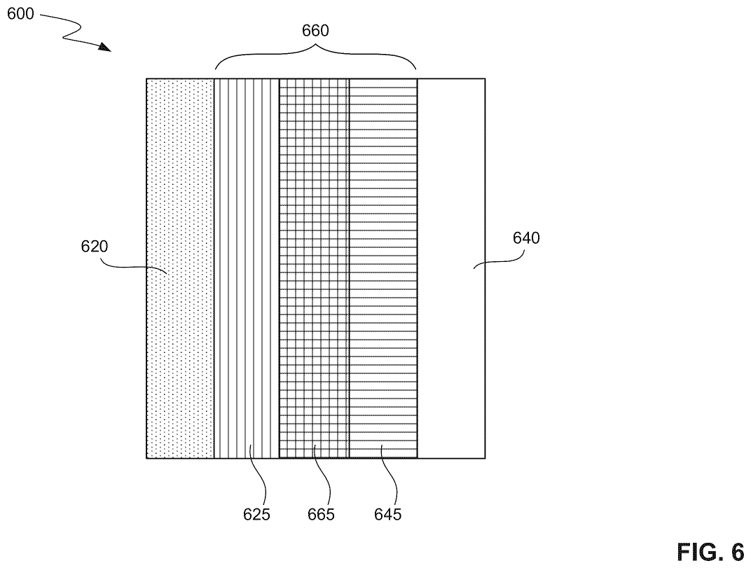

An example MEA 600 for use in COₓ reduction is shown in FIG. 6. The MEA 600 has a cathode layer 620 and an anode layer 640 separated by an ion-conducting polymer layer 660 that provides a path for ions to travel between the cathode layer 620 and the anode layer 640. In certain embodiments, the cathode layer 520 includes an anion-conducting polymer and/or the anode layer 640 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 660 may include two or three sublayers: a polymer electrolyte membrane (PEM) 665, an optional cathode buffer layer 625, and/or an optional anode buffer layer 645. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 665 is nonporous. Example characteristics of anode buffer layers and cathode buffer layers are provided elsewhere herein. In certain embodiments, the ion-conducting layer includes only a single layer or two sublayers.

In some embodiments, a carbon oxide electrolyzer anode contains a blend of oxidation catalyst and an ion-conducting polymer. There are a variety of oxidation reactions that can occur at the anode depending on the reactant that is fed to the anode and the anode catalyst(s). In one arrangement, the oxidation catalyst is selected from the group consisting of metals and oxides of Ir, Pt, Ni, Ru, Pd, Au, and alloys thereof, IrRu, PtIr, Ni, NiFe, stainless steel, and combinations thereof. The oxidation catalyst can further contain conductive support particles such as carbon, boron-doped diamond, titanium, and any combination thereof.

As examples, the oxidation catalyst can be in the form of a structured mesh or can be in the form of particles. If the oxidation catalyst is in the form of particles, the particles can be supported by electronically conductive support particles. The conductive support particles can be nanoparticles. The conductive support particles may be compatible with the chemicals that are present in an electrolyzer anode when the electrolyzer is operating and are oxidatively stable so that they do not participate in any electrochemical reactions. It is especially useful if the conductive support particles are chosen with the voltage and the reactants at the anode in mind. In some arrangements, the conductive support particles are titanium, which is well-suited for high voltages. In other arrangements, the conductive support particles are carbon, which can be most useful at low voltages. In some embodiments, such conductive support particles are larger than the oxidation catalyst particles, and each conductive support particle can support one or more oxidation catalyst particles. In one arrangement, the oxidation catalyst is iridium ruthenium oxide. Examples of other materials that can be used for the oxidation catalyst include, but are not limited to, those listed above. It should be understood that many of these metal catalysts can be in the form of oxides, especially under reaction conditions.

As mentioned, in some embodiments, an anode layer of an MEA includes an ion-conducting polymer. In some cases, this polymer contains one or more covalently bound, negatively charged functional groups configured to transport mobile positively charged ions. Examples of the second ion-conducting polymer include ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof. Commercially available examples of cation-conducting polymers include e.g., Nafion 115, Nafion 117, and/or Nafion 211. Other examples of cationic conductive ionomers described above are suitable for use in anode layers.

There may be tradeoffs in choosing the amount of ion-conducting polymer in the anode. For example, an anode may include enough anode ion-conducting polymer to provide sufficient ionic conductivity, while being porous so that reactants and products can move through it easily. An anode may also be fabricated to maximize the amount of catalyst surface area that is available for reaction. In various arrangements, the ion-conducting polymer in the anode makes up about 10 and 90 wt %, or about 20 and 80 wt %, or about 25 and 70 wt % of the total anode mass. As an example, the ion-conducting polymer may make up about 5 and 20 wt % of the anode. In certain embodiments, the anode may be configured to tolerate relatively high voltages, such as voltages above about 1.2 V vs. a reversible hydrogen electrode. In some embodiments, an anode is porous in order to maximize the amount of catalyst surface area available for reaction and to facilitate gas and liquid transport.

In some embodiments, the MEA and/or the associated cathode layer is designed or configured to accommodate gas generated in situ. Such gas may be generated via various mechanisms. For example, carbon dioxide may be generated when carbonate or bicarbonate ions moving from the cathode toward the anode encounter hydrogen ions moving from the anode toward the cathode. This encounter may occur, for example, at the interface of anionic and cationic conductive ionomers in a bipolar MEA. Alternatively, or in addition, such contact may occur at the interface of a cathode layer and a polymer electrolyte membrane. For example, the polymer electrolyte membrane may contain a cationic conductive ionomer that allows transport of protons generated at the anode. The cathode layer may include an anion conductive ionomer.

Left unchecked, the generation of carbon dioxide or other gas may cause the MEA to delaminate or otherwise be damaged. It may also prevent a fraction of the reactant gas from being reduced at the anode.

The location within or adjacent to an MEA where a gas such as carbon dioxide is generated in situ may contain one or more structures designed to accommodate such gas and, optionally, prevent the gas from reaching the anode, where it would be otherwise unavailable to react.

In certain embodiments, pockets or voids are provided at a location where the gas is generated. These pockets or voids may have associated pathways that allow the generated gas to exit from the MEA, optionally to the cathode where, for example, carbon dioxide can be electrochemically reduced. In certain embodiments, an MEA includes discontinuities at an interface of anionic and cationic conductive ionomer layers such as at such interface in a bipolar MEA. In some embodiments, a cathode structure is constructed in a way that includes pores or voids that allow carbon dioxide generated at or proximate to the cathode to evacuate into the cathode.

In some embodiments, such discontinuities or void regions are prepared by fabricating in MEA in a way that separately fabricates anode and cathode structures, and then sandwiches to the two separately fabricated structures together in a way that produces the discontinuities or voids.

In some embodiments, and MEA structure is fabricated by depositing copper or other catalytic material onto a porous or fibrous matrix such as a fluorocarbon polymer and then coating the resulting structure with an anionic conductive ionomer. In some embodiments, the coated structure is then attached to the remaining MEA structure, which may include an anode and a polymer electrolyte membrane such as a cationic conductive membrane.

In some embodiments, a cathode has a porous structure and the/or an associated cathode buffer layer that has a porous structure. The pores may be present in an open cell format that allows generated carbon dioxide or other gas to find its way to the cathode.

In some MEAs, an interface between an anion conducting layer and a cation conducting layer (e.g., the interface of a cathode buffer layer and a PEM) includes a feature that resists delamination caused by carbon dioxide, water, or other material that may form at the interface. In some embodiments, the feature provides void space for the generated material to occupy until as it escapes from an MEA. In some examples, natural porosity of a layer such as an anion conducting layer provides the necessary void space. An interconnected network of pores may provide an escape route for carbon dioxide or other gas generated at the interface. In some embodiments, an MEA contains interlocking structures (physical or chemical) at the interface. In some embodiments, an MEA contains discontinuities at the interface. In some embodiments, an MEA contains of a fibrous structure in one layer adjacent the interface. A further discussion of interfacial structures between anion and cation conducting layers of MEAs is contained in Published PCT Application No. 2021/108446, published Jun. 3, 2021, and titled “MEMBRANE ELECTRODE ASSEMBLY FOR COₓ REDUCTION,” which is incorporated herein by reference in its entirety.

### Cathode Catalyst Layer

A function of the cathode catalyst layer is to provide a catalyst for COₓ reduction. An example reaction is:

CO₂+2H⁺+2e⁻→CO+H₂O.

The cathode catalyst layer may also have other functions that facilitate COₓ conversion. These include water management, gas transport, reactant delivery to the metal catalyst, product removal, stabilizing the particulate structure of the metal catalyst, electronic and ionic conduction to the metal catalyst, and mechanical stability within the MEA.

Certain functions and challenges are particular to carbon oxide electrolyzers and are not found in MEA assemblies for other applications such as fuel cells or water electrolyzers. These challenges include that the cathode catalyst layer of the MEA transports gas (e.g., CO₂ or CO) in and gas (e.g., ethylene, methane, CO) or liquid (e.g., ethanol) out. The cathode catalyst layer may be designed or configured to prevent accumulation of water that can block gas transport. Further, catalysts for COₓ reduction are sometimes less stable than catalysts like platinum that can be used in hydrogen fuel cells. These functions, their particular challenges, and how they can be addressed are described below.

### Water Management (Cathode Catalyst Layer)

The cathode catalyst layer facilitates movement of water to prevent it from being trapped in the cathode catalyst layer. Trapped water can hinder access of COₓ to the catalyst and/or hinder movement of reaction product out of the cathode catalyst layer.

Water management challenges are in many respects unique to COₓ electrolyzers. For example, compared to a PEM fuel cell's oxygen electrode, a COₓ electrolyzer uses a much lower gas flow rate. A COₓ electrolyzer also may use a lower flow rate to achieve a high utilization of the input COₓ. Vapor phase water removal is determined by the volumetric gas flow, thus much less vapor phase water removal is carried out in a COₓ electrolyzer. A COₓ electrolyzer may also operate at higher pressure (e.g., 100 psi-450 psi) than a fuel cell; at higher pressure the same molar flow results in lower volumetric flow and lower vapor phase water removal. For some MEAs, the ability to remove vapor phase water is further limited by temperature limits not present in fuel cells. For example, CO₂ to CO reduction may be performed at about 50° C. and ethylene and methane production may be performed at 20° C.-25° C. This is compared to typical operating temperatures of 80° C. to 120° C. for fuel cells. As a result, there is even more liquid phase water to remove.

Properties that affect ability of the cathode catalyst layer to remove water include porosity; pore size; distribution of pore sizes; hydrophobicity; the relative amounts of ion conducting polymer, metal catalyst particles, and electronically-conductive support; the thickness of the layer; the distribution of the catalyst throughout the layer; and the distribution of the ion conducting polymer through the layer and around the catalyst.

A porous layer allows an egress path for water. In some embodiments, the cathode catalyst layer has a pore size distribution that includes some pores having sizes of about 1 nm-100 nm and other pores having sizes of at least about 1 micron. This size distribution can aid in water removal. The porous structures could be formed by one or more of: pores within the carbon supporting structures (e.g., support particles); stacking pores between stacked carbon nanoparticles; secondary stacking pores between agglomerated carbon spheres (micrometer scale); or inert filler (e.g., PTFE) introduced pores with the interface between the PTFE and carbon also creating irregular pores ranging from hundreds of nm to micrometers.

The thickness of cathode catalyst layer may contribute to water management. Using a thicker layer allows the catalyst and thus the reaction to be distributed in a larger volume. This spreads out the water distribution and makes it easier to manage. In certain embodiments, the cathode layer thickness is about 80 nm-300 μm.

Ion-conducting polymers having non-polar, hydrophobic backbones may be used in the cathode catalyst layer. In some embodiments, the cathode catalyst layer may include a hydrophobic polymer such as PTFE in addition to the ion-conducting polymer. In some embodiments, the ion-conducting polymer may be a component of a co-polymer that also includes a hydrophobic polymer. In some embodiments, the ion-conducting polymer has hydrophobic and hydrophilic regions. The hydrophilic regions can support water movement and the hydrophobic regions can support gas movement.

### Gas Transport (Cathode Catalyst Layer)

The cathode catalyst layer is structured for gas transport. Specifically, COₓ is transported to the catalyst and gas phase reaction products (e.g., CO, ethylene, methane, etc.) is transported out of the catalyst layer.

Certain challenges associated with gas transport are unique to COₓ electrolyzers. Gas is transported both in and out of the cathode catalyst layer—COₓ in and products such as CO, ethylene, and methane out. In a PEM fuel cell, gas (O₂ or H₂) is transported in but nothing or product water comes out. And in a PEM water electrolyzer, water is the reactant with O₂ and H₂ gas products.

Operating conditions including pressures, temperature, and flow rate through the reactor affect the gas transport. Properties of the cathode catalyst layer that affect gas transport include porosity; pore size and distribution; layer thickness; and ionomer distribution. Example values of these parameters are provided elsewhere herein.

In some embodiments, the ionomer-catalyst contact is minimized. For example, the ionomer may form a continuous network along the surface of the carbon with minimal contact with the catalyst. The ionomer, support, and catalyst may be designed such that the ionomer has a higher affinity for the support surface than the catalyst surface. This can facilitate gas transport to and from the catalyst without being blocked by the ionomer, while allowing the ionomer to conduct ions to and from the catalyst.

### Ionomer (Cathode Catalyst Layer)

The ionomer may have multiple functions including holding particles of the catalyst layer together and allowing movement of ions through the cathode catalyst layer. In some cases, the interaction of the ionomer and the catalyst surface may create an environment favorable for COₓ reduction, increasing selectivity to a desired product and/or decreasing the voltage required for the reaction. Importantly, the ionomer is an ion-conducting polymer that allows the movement of ions through the cathode catalyst layer. Hydroxide, bicarbonate, and carbonate ions, for example, are moved away from the catalyst surface where the COₓ reduction occurs.

In certain embodiments, an ion-conducting polymer of a cathode comprises at least one ion-conducting polymer that is an anion-conductor. This can be advantageous because it raises the pH compared to a proton conductor.

Various anion-conducting polymers are described above. Some of these have aryl groups in their backbones. Such ionomers may be used in cathode catalyst layers as described herein. In some embodiments, an ion-conducting polymer can comprise one or more covalently bound, positively charged functional groups configured to transport mobile negatively charged ions.

In some embodiments, an ion-conducting polymer in a cathode comprises at least one ion-conducting polymer that is a cation and an anion-conductor. Examples of such ion-conducting polymer include polyethers that can transport cations and anions and polyesters that can transport cations and anions. Further examples of such ion-conducting polymer include polyethylene oxide, polyethylene glycol, polyvinylidene fluoride, and polyurethane.

During use in an electrolyzer, a cation and anion conductor may raise the local pH (compared to a pure cation conductor.) Further, in some embodiments, it may be advantageous to use a cation and anion conductor to promote acid base recombination in a larger volume instead of at a 2D interface of anion-conducting polymer and cation conducting polymer. This can spread out water and CO₂ formation, heat generation, and potentially lower the resistance of the membrane by decreasing the barrier to the acid-base reaction. All of these may be advantageous in helping avoid the buildup of products, heat, and lowering resistive losses in the MEA leading to a lower cell voltage.

In certain embodiments, an anion-conducting polymer has a polymer backbone with covalently bound positively charged functional groups appended. These may include positively charged nitrogen groups in some embodiments. In some embodiments, the polymer backbone is non-polar, as described above. The polymer may have any appropriate molecular weight, e.g., 25,000 g/mol-150,000 g/mol, though it will be understood that polymers outside this range may be used.

According to various embodiments, the ion-conducting polymer may have a bicarbonate ionic conductivity of at least 6 mS/cm, or in some embodiments at least 12 mS/cm, is chemically and mechanically stable at temperatures 80° C. and lower, and soluble in organic solvents used during fabrication such as methanol, ethanol, and isopropanol. The ion-conducting polymer is stable (chemically and has stable solubility) in the presence of the COₓ reduction products. The ion-conducting polymer may also be characterized by its ion exchange capacity, the total of active sites or functional groups responsible for ion exchange, which may range from 2.1 mmol/g-2.6 mmol/g in some embodiments. In some embodiments, ion-conducting polymers having lower IECs such as greater than 1 or 1.5 mmol/g may be used.

Examples of anion-conducting polymers are given above in above table as Class A ion-conducting polymers.

The as-received polymer may be prepared by exchanging the anion (e.g., I—, Br—, etc.) with bicarbonate.

Also, as indicated above, in certain embodiments the ionomer may be a cation-and-anion-conducting polymer. Examples are given in the above table as Class B ion-conducting polymers.

There are tradeoffs in choosing the amount of ion-conducting polymer in the cathode. A cathode may include enough cathode ion-conducting polymer to provide sufficient ionic conductivity but be sufficiently porous so that reactants and products can move through it easily and to maximize the amount of catalyst surface area that is available for reaction. In various arrangements, the cathode ion-conducting polymer makes up about 10 to 90 wt %, about 20 to 80 wt %, or about 30 to 70 wt % of the material in the cathode layer.

### Metal Catalyst (Cathode Catalyst Layer)

In certain embodiments, metal catalysts have one or more of the properties presented above. In general, a metal catalyst catalyzes one or more COₓ reduction reactions. The metal catalyst may be in the form of nanoparticles, but larger particles, films, and nanostructured surfaces may be used in some embodiments. The specific morphology of the nanoparticles may expose and stabilize active sites that have greater activity.

Examples of materials that can be used for the reduction catalyst particles include, but are not limited, to transition metals such as V, Cr, Mn, Fe, Co, Ni, Cu, Zr, Nb, Mo, Au, Ru, Rh, Pd, Ag, Cd, Hf, Ta, W, Re, Ir, Pt, and Hg, and combinations thereof, and/or any other suitable materials. Other catalyst materials can include alkali metals, alkaline earth metals, lanthanides, actinides, and post transition metals, such as Sn, Si, Ga, Pb, Al, Tl, Sb, Te, Bi, Sm, Tb, Ce, Nd and In or combinations thereof, and/or any other suitable catalyst materials. The choice of catalyst depends on the reaction performed at the cathode of the COₓ electrolyzer.

The metal catalyst may be composed of pure metals (e.g., Cu, Au, Ag), but alloys or bimetallic systems may be used for certain reactions. In some embodiments, a metal catalyst comprises a dopant. Examples of dopants include boron, nitrogen, and hydrogen. In some cases, the metal catalyst comprises boron-doped copper. The concentration of dopant may be substantially uniform throughout the metal particle or it may vary as a function of distance from particle surface. For example, the dopant concentration may decrease with distance from the particle surface.

The choice of catalyst may be guided by the desired reaction. For example, for CO production, Au may be used; for methane and ethylene production, Cu may be used. CO₂ reduction has a high overpotential compared to other well-known electrochemical reactions such as hydrogen evolution and oxygen evolution on known catalysts. Small amounts of contaminants can poison catalysts for CO₂ conversion.

Different metal catalyst materials may be chosen at least in part based on the desired product and MEA operation. For example, the 1D nanowire may have a higher selectivity for ethylene production while triangular Cu nanoplates may have higher selectivity for methane. Nanocubes may show good selectivity for ethylene in an AEM MEA.

### Support (Cathode Catalyst Layer)

As explained above, support structures may be particles. But more generally, they may have many different shapes such as spheres, polygons (e.g., triangles), nanotubes, and sheets (e.g., graphene)). Structures having high surface area to volume are useful to provide sites for catalyst particles to attach. Support structures may also be characterized by their porosity, surface area per volume, electrical conductivity, functional groups (N-doped, O-doped, etc), and the like. Various characteristics of particulate support structures are presented above.

If present, a support of the cathode catalyst particles may have any of various functions. It may stabilize metal nanoparticles to prevent them from agglomerating and distribute the catalytic sites throughout the catalyst layer volume to spread out loss of reactants and formation of products. A support may also provide an electrically conductive pathway to metal nanoparticles. Carbon particles, for example, pack together such that contacting carbon particles provide the electrically conductive pathway. Void space between the particles forms a porous network that gas and liquids can travel through.

The support may be hydrophobic and have affinity to the metal nanoparticle.

In many cases, the conductive support particles are compatible with the chemicals that are present in the cathode during operation, are reductively stable, and have a high hydrogen production overpotential so that they do not participate in any electrochemical reactions. In certain embodiments, conductive support particles are larger than the reduction catalyst particles, and each conductive support particle can support many reduction catalyst particles.

Examples of carbon blacks that can be used include:
Vulcan XC-72R—Density of 256 mg/cm², 30-50 nm
Ketjen Black—Hollow structure, Density of 100-120 mg/cm², 30-50 nm
Printex Carbon, 20-30 nm

### Properties of the Cathode Catalyst Layer

In certain embodiments, a cathode layer has a porosity of about 15 to 75%. Porosity of the cathode layer may be determined by various techniques. In one method, the loading of each component (e.g., catalyst, support, and polymer) is multiplied by its respective density. These are added together to determine the thickness the components take up in the material. This is then divided by the total known thickness to obtain the percentage of the layer that is occupied by the material. The resulting percentage is then subtracted from 1 to obtain the percentage of the layer assumed to be void space (e.g., filled with air or other gas or a vacuum), which is the porosity. In some embodiments, porosity is determined directly by a method such as mercury porosimetry or image analysis of TEM images.

The cathode layer may also be characterized by its roughness. The surface characteristics of the cathode layer can impact the resistances across the membrane electrode assembly. Excessively rough cathode layers can potentially lead to interfacial gaps between the catalyst and a current collectors or other electronically conductive support layer such as a microporous layer. These gaps hinder electron transfer from the current collector to the catalytic area, thus, increasing contact resistances. Interfacial gaps may also serve as locations for water accumulation that is detrimental to mass transport of reactants and products. On the other hand, extremely smooth surfaces may suffer from poor adhesion between layers. Cathode layer roughness may influence electrical contact resistances and concentration polarization losses. Surface roughness can be measured using different techniques (e.g. mechanical stylus method, optical profilometry, or atomic force microscopy) and is defined as the high-frequency, short wavelength component of a real surface. Arithmetic mean height, Sa, is a parameter that is commonly used to evaluate the surface roughness. Numerically, it is calculated by integrating the absolute height of valleys and peaks on the surface relative to the mean plane over the entire geometric area of the sample. Cathode layer Sa values between 0.50-1.10 μm or 0.70-0.90 μm may be used in some embodiments.

Examples of cathode catalyst layer characteristics for CO, methane, and ethylene/ethanol productions:
CO production: Au nanoparticles 4 nm in diameter supported on Vulcan XC72R carbon and mixed with TM1 anion exchange polymer electrolyte from Orion. Layer is about 15 μm thick, Au/(Au+C)=30%, TM1 to catalyst mass ratio of 0.32, mass loading of 1.4-1.6 mg/cm², estimated porosity of 0.47
Methane production: Cu nanoparticles of 20-30 nm size supported on Vulcan XC72R carbon, mixed with FAA-3 anion exchange solid polymer electrolyte from Fumatech. FAA-3 to catalyst mass ratio of 0.18. Estimated Cu nanoparticle loading of ˜7.1 μg/cm², within a wider range of 1-100 μg/cm²
Ethylene/ethanol production: Cu nanoparticles of 25-80 nm size, mixed with FAA-3 anion exchange solid polymer electrolyte from Fumatech. FAA-3 to catalyst mass ratio of 0.10. Deposited either on Sigracet 39BC GDE for pure AEM or onto the polymer-electrolyte membrane. Estimated Cu nanoparticle loading of 270 μg/cm².
Bipolar MEA for methane production: The catalyst ink is made up of 20 nm Cu nanoparticles supported by Vulcan carbon (Premetek 40% Cu/Vulcan XC-72) mixed with FAA-3 anion exchange solid polymer electrolyte (Fumatech), FAA-3 to catalyst mass ratio of 0.18. The cathode is formed by the ultrasonic spray deposition of the catalyst ink onto a bipolar membrane including FAA-3 anion exchange solid polymer electrolyte spray-coated on Nafion (PFSA) 212 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
Bipolar MEA for ethylene production: The catalyst ink is made up of pure 80 nm Cu nanoparticles (Sigma Aldrich) mixed with FAA-3 anion exchange solid polymer electrolyte (Fumatech), FAA-3 to catalyst mass ratio of 0.09. The cathode is formed by the ultrasonic spray deposition of the catalyst ink onto a bipolar membrane including FAA-3 anion exchange solid polymer electrolyte spray-coated on Nafion (PFSA) 115 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
CO production: Au nanoparticles 4 nm in diameter supported on Vulcan XC72R carbon and mixed with TM1 anion exchange polymer electrolyte from Orion. Layer is about 14 micron thick, Au/(Au+C)=20%. TM1 to catalyst mass ratio of 0.32, mass loading of 1.4-1.6 mg/cm², estimated porosity of 0.54 in the catalyst layer.
CO production: Au nanoparticles 45 nm in diameter supported on Vulcan XC72R carbon and mixed with TM1 anion exchange polymer electrolyte from Orion. Layer is about 11 micron thick, Au/(Au+C)=60%. TM1 to catalyst mass ratio of 0.16, mass loading of 1.1-1.5 mg/cm², estimated porosity of 0.41 in the catalyst layer.
CO production: Au nanoparticles 4 nm in diameter supported on Vulcan XC72R carbon and mixed with TM1 anion exchange polymer electrolyte from Orion. Layer is about 25 micron thick, Au/(Au+C)=20%. TM1 to catalyst mass ratio of 0.32, mass loading of 1.4-1.6 mg/cm², estimated porosity of 0.54 in the catalyst layer.

### PEM

MEAs may include a polymer electrolyte membrane (PEM) disposed between and conductively coupled to the anode catalyst layer and the cathode catalyst layer. In certain embodiments, a polymer electrolyte membrane has high ionic conductivity (e.g., greater than about 1 mS/cm) and is mechanically stable. Mechanical stability can be evidenced in a variety of ways such as through high tensile strength, modulus of elasticity, elongation to break, and tear resistance. Many commercially available membranes can be used for the polymer electrolyte membrane. Examples include, but are not limited to, various Nafion® formulations, GORE-SELECT, FumaPEM® (PFSA) (FuMA-Tech GmbH), and Aquivion® (PFSA) (Solvay).

In one arrangement, the PEM comprises at least one ion-conducting polymer that is a cation-conductor. The third ion-conducting polymer can comprise one or more covalently-bound, negatively-charged functional groups configured to transport mobile positively-charged ions. The third ion-conducting polymer can be selected from the group consisting of ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof.

### Cathode Buffer Layer

When the polymer electrolyte membrane is a cation conductor (e.g., it conducts protons), it may contain a high concentration of protons during operation of the CRR, while a cathode may operate better when a low concentration of protons is present. A cathode buffer layer may be provided between the polymer electrolyte membrane and the cathode to provide a region of transition from a high concentration of protons to a low concentration of protons. In one arrangement, a cathode buffer layer is an ion-conducting polymer with many of the same properties as the ion-conducting polymer in the cathode. A cathode buffer layer may provide a region for the proton concentration to transition from a polymer electrolyte membrane, which has a high concentration of protons, to the cathode, which has a low proton concentration. Within the cathode buffer layer, protons from the polymer electrolyte membrane may encounter anions from the cathode, and they may neutralize one another. The cathode buffer layer may help ensure that a deleterious number of protons from the polymer electrolyte membrane does not reach the cathode and raise the proton concentration. If the proton concentration of the cathode is too high, COₓ reduction does not occur. A high proton concentration may be a concentration in the range of about 10 to 0.1 molar and low proton concentration may be a concentration of less than about 0.01 molar.

A cathode buffer layer can include a single polymer or multiple polymers. If the cathode buffer layer includes multiple polymers, the multiple polymers can be mixed together or can be arranged in separate, adjacent layers. Examples of materials that can be used for the cathode buffer layer include, but are not limited to, FumaSep FAA-3, Tokuyama anion exchange membrane material, and polyether-based polymers, such as polyethylene oxide (PEO), and blends thereof. Further examples are given above in the discussion of the cathode catalyst layer.

The thickness of the cathode buffer layer is chosen to be sufficient that COₓ reduction activity is high due to the proton concentration being low. This sufficiency can be different for different cathode buffer layer materials. In general, the thickness of the cathode buffer layer is between approximately 200 nm and 100 μm, between 300 nm and 75 μm, between 500 nm and 50 μm, or any suitable range.

In some embodiments, the cathode buffer layer is less than 50 μm, for example between 1-25 μm such between 1-5 μm, 5-15 μm, or 10-25 μm. By using a cathode buffer layer in this range of thicknesses, the proton concentration in the cathode can be reduced while maintaining the overall conductivity of the cell. In some embodiments, an ultra-thin layer (100 nm-1 μm and in some embodiments, sub-micron) may be used. And as discussed above, in some embodiments, the MEA does not have a cathode buffer layer. In some such embodiments, anion-conducting polymer in the cathode catalyst layer is sufficient. The thickness of the cathode buffer layer may be characterized relative to that of the PEM.

Water and CO₂ formed at the interface of a cathode buffer layer and a PEM can delaminate the MEA where the polymer layers connect. The delamination problem can be addressed by employing a cathode buffer layer having inert filler particles and associated pores. One possible explanation of its effectiveness is that the pores create paths for the gaseous carbon dioxide to escape back to the cathode where it can be reduced.

Materials that are suitable as inert filler particles include, but are not limited to, TiO₂, silica, PTFE, zirconia, and alumina. In various arrangements, the size of the inert filler particles is between 5 nm and 500 μm, between 10 nm and 100 μm, or any suitable size range. The particles may be generally spherical.

If PTFE (or other filler) volume is too high, it will dilute the polymer electrolyte to the point where ionic conductivity is low. Too much polymer electrolyte volume will dilute the PTFE to the point where it does not help with porosity. In many embodiments a mass ratio of polymer electrolyte/PTFE is 0.25 to 2, and more particularly, 0.5 to 1. A volume ratio polymer electrolyte/PTFE (or, more generally, polymer electrolyte/inert filler) may be 0.25 to 3, 0.5 to 2, 0.75 to 1.5, or 1.0 to 1.5.

In other arrangements, porosity is achieved by using particular processing methods when the layers are formed. One example of such a processing method is laser ablation, where nano to micro-sized channels are formed in the layers. Another example is mechanically puncturing a layer to form channels through it.

In one arrangement, the cathode buffer layer has a porosity between 0.01% and 95% (e.g., approximately between, by weight, by volume, by mass, etc.). However, in other arrangements, the cathode buffer layer can have any suitable porosity (e.g., between 0.01-95%, 0.1-95%, 0.01-75%, 1-95%, 1-90%). In some embodiments, the porosity is 50% or less, e.g., 0.1-50%, 5-50%, 20-50%, 5-40%, 10-40%, 20-40%, or 25%-40%. In some embodiments, the porosity is 20% or below, e.g. 0.1-20%, 1-10%, or 5-10%.

Porosity may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation.

Porosity in layers of the MEA, including the cathode buffer layer, is described further below.

### Anode Buffer Layer

In some CRR reactions, bicarbonate is produced at the cathode. It can be useful if there is a polymer that blocks bicarbonate transport somewhere between the cathode and the anode, to prevent migration of bicarbonate away from the cathode. It can be that bicarbonate takes some CO₂ with it as it migrates, which decreases the amount of CO₂ available for reaction at the cathode. In some MEAs, the polymer electrolyte membrane includes a polymer that blocks bicarbonate transport. Examples of such polymers include, but are not limited to, Nafion® formulations, GORE-SELECT, FumaPEM® (PFSA) (FuMA-Tech GmbH), and Aquivion @(PFSA) (Solvay). In some MEAs, there is an anode buffer layer between the polymer electrolyte membrane and the anode, which blocks transport of bicarbonate. If the polymer electrolyte membrane is an anion-conductor, or does not block bicarbonate transport, then an additional anode buffer layer to prevent bicarbonate transport can be useful. Materials that can be used to block bicarbonate transport include, but are not limited to Nafion® formulations, GORE-SELECT, FumaPEM® (PFSA) (FuMA-Tech GmbH), and Aquivion® (PFSA) (Solvay). Of course, including a bicarbonate blocking feature in the ion-exchange layer is not particularly desirable if there is no bicarbonate in the CRR.

In certain embodiments, an anode buffer layer provides a region for proton concentration to transition between the polymer electrolyte membrane to the anode. The concentration of protons in the polymer electrolyte membrane depends both on its composition and the ion it is conducting. For example, a Nafion polymer electrolyte membrane conducting protons has a high proton concentration. A FumaSep FAA-3 polymer electrolyte membrane conducting hydroxide has a low proton concentration. For example, if the desired proton concentration at the anode is more than 3 orders of magnitude different from the polymer electrolyte membrane, then an anode buffer layer can be useful to affect the transition from the proton concentration of the polymer electrolyte membrane to the desired proton concentration of the anode. The anode buffer layer can include a single polymer or multiple polymers. If the anode buffer layer includes multiple polymers, the multiple polymers can be mixed together or can be arranged in separate, adjacent layers. Materials that can be useful in providing a region for the pH transition include, but are not limited to, Nafion, FumaSep FAA-3, Sustainion®, Tokuyama anion exchange polymer, and polyether-based polymers, such as polyethylene oxide (PEO), blends thereof, and/or any other suitable materials. High proton concentration is considered to be in the range of approximately 10 to 0.1 molar and low concentration is considered to be less than approximately 0.01 molar. Ion-conducting polymers can be placed in different classes based on the type(s) of ions they conduct. This has been discussed in more detail above. There are three classes of ion-conducting polymers described in Table 1 above. In one embodiment of the invention, at least one of the ion-conducting polymers in the cathode, anode, polymer electrolyte membrane, cathode buffer layer, and anode buffer layer is from a class that is different from at least one of the others.

### Layer Porosity

It can be useful if some or all of the following layers are porous: the cathode, the cathode buffer layer, the anode and the anode buffer layer. In some arrangements, porosity is achieved by combining inert filler particles with the polymers in these layers. Materials that are suitable as inert filler particles include, but are not limited to, TiO₂, silica, PTFE, zirconia, and alumina. In various arrangements, the size of the inert filler particles is between 5 nm and 500 μm, between 10 nm and 100 μm, or any suitable size range. In other arrangements, porosity is achieved by using particular processing methods when the layers are formed. One example of such a processing method is laser ablation, where nano to micro-sized channels are formed in the layers. Laser ablation can additionally or alternatively achieve porosity in a layer by subsurface ablation. Subsurface ablation can form voids within a layer, upon focusing the beam at a point within the layer, and thereby vaporizing the layer material in the vicinity of the point. This process can be repeated to form voids throughout the layer, and thereby achieving porosity in the layer. The volume of a void is preferably determined by the laser power (e.g., higher laser power corresponds to a greater void volume) but can additionally or alternatively be determined by the focal size of the beam, or any other suitable laser parameter. Another example is mechanically puncturing a layer to form channels through the layer. The porosity can have any suitable distribution in the layer (e.g., uniform, an increasing porosity gradient through the layer, a random porosity gradient, a decreasing porosity gradient through the layer, a periodic porosity, etc.).

The porosities (e.g., of the cathode buffer layer, of the anode buffer layer, of the membrane layer, of the cathode layer, of the anode layer, of other suitable layers, etc.) of the examples described above and other examples and variations preferably have a uniform distribution, but can additionally or alternatively have any suitable distribution (e.g., a randomized distribution, an increasing gradient of pore size through or across the layer, a decreasing gradient of pore size through or across the layer, etc.). The porosity can be formed by any suitable mechanism, such as inert filler particles (e.g., diamond particles, boron-doped diamond particles, polyvinylidene difluoride/PVDF particles, polytetrafluoroethylene/PTFE particles, etc.) and any other suitable mechanism for forming substantially non-reactive regions within a polymer layer. The inert filler particles can have any suitable size, such as a minimum of about 10 nanometers and a maximum of about 200 nanometers, and/or any other suitable dimension or distribution of dimensions.

As discussed above, the cathode buffer layer preferably has a porosity between about 1 and 90 percent by volume but can additionally or alternatively have any suitable porosity (including, e.g., no porosity). However, in other arrangements and examples, the cathode buffer layer can have any suitable porosity (e.g., between 0.01-95%, 0.1-95%, 0.01-75%, 1-95%, 1-90%, etc.). in some embodiments, the porosity is 20% or below, e.g., 0.1-20%, 1-10%, or 5-10%.

In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode.

### Co₂ Electrolyzer Outputs

A CO₂ purifier and electrolyzer integrated system may output one or more chemically reduced CO₂ products from the electrolyzer's cathode. Such outputs may include one or more carbon-containing products such as carbon monoxide, one or more hydrocarbons (e.g., methane, ethene, and/or ethane), one or more alcohols (e.g., methanol, ethanol, n-propanol, and/or ethylene glycol), one or more aldehydes (e.g., glycolaldehyde, acetaldehyde, glyoxal, and/or propionaldehyde), one or more ketones (e.g., acetone and/or hydroxyacetone), one or more carboxylic acids (e.g., formic acid and/or acetic acid), and any combination thereof. The electrolyzer's cathode may also produce H₂. A CO₂ purifier and electrolyzer integrated system may output one or more chemically oxidized H₂O products such as oxygen. Additional outputs of an electrolyzer may include unreacted CO₂ and/or unreacted H₂O.

### OTHER EMBODIMENTS AND CONCLUSION

Although omitted for conciseness, embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

Although the foregoing embodiments have been described in some detail for purposes of clarity of understanding, it will be apparent that certain changes and modifications may be practiced within the scope of the appended claims. It should be noted that there are many alternative ways of implementing the processes, systems and apparatus of the present embodiments. Accordingly, the present embodiments are to be considered as illustrative and not restrictive, and the embodiments are not to be limited to the details given herein.

What is claimed is:

1. A system comprising:
a CO₂ purifier comprising:
(a) an inlet for receiving impure CO₂,
(b) a cathode,
(c) an anode,
(d) a plurality of parallel liquid flow paths between the anode and the cathode, wherein the plurality of parallel liquid flow paths comprise:
(i) a carbonate donating flow path configured to flow a first solution containing carbonate and/or bicarbonate ions and bounded on its anode-facing side by an anion exchange membrane, and
(ii) a carbonate receiving flow path arranged adjacent to, and on the anode side of, said carbonate donating flow path and configured to flow a second solution that is more acidic than the first solution, wherein the carbonate receiving flow path is bounded on its cathode-facing side by said anion exchange membrane that allows the carbonate and/or bicarbonate ions to pass from the carbonate donating flow path to the carbonate receiving flow path, and
(e) an outlet for removing purified CO₂; and
a CO₂ electrolyzer configured to receive the purified CO₂ from the CO₂ purifier, the CO₂ electrolyzer comprising an electrolyzer cathode configured to electrochemically reduce CO₂ to produce a carbon containing product.

2. The system of claim 1, wherein the carbonate donating flow path is bounded on its cathode-facing side by a bipolar membrane.

3. The system of claim 1, wherein the carbonate receiving flow path is bounded on its anode-facing side by a bipolar membrane.

4. The system of claim 3, wherein the plurality of parallel liquid flow paths further comprises:
(iii) a second carbonate donating flow path configured to flow the first solution and bounded on its cathode-facing side by the bipolar membrane and bounded on its anode-facing side by a second anion exchange membrane, and
(iv) a second carbonate receiving flow path arranged adjacent to, and on the anode side of, said second carbonate donating flow path and configured to flow the second solution, wherein the second carbonate receiving flow path is bounded on its cathode-facing side by said second anion exchange membrane.

5. The system of claim 4, wherein the second carbonate receiving flow path is bounded on its anode-facing side by a second bipolar membrane.

6. The system of claim 1, further comprising a first solution tank configured to supply the first solution to the carbonate donating flow path; and a recycle path configured to recycle the first solution from the carbonate donating flow path to the first solution tank.

7. The system of claim 1, further comprising a second solution tank configured to supply the second solution to the carbonate receiving flow path; and a recycle path configured to recycle the second solution from the carbonate receiving flow path to the second tank.

8. The system of claim 1, wherein the plurality of parallel liquid flow paths further comprise:
(iii) a cation-donating flow path adjacent to the anode and bounded on its cathode-facing side by a first cation exchange membrane configured to transport cations to the first solution, and
(iv) a cation-receiving flow path adjacent to the cathode and bounded on its anode-facing side by a second cation exchange membrane configured receive cations from the first solution.

9. The system of claim 1, wherein the CO₂ electrolyzer is directly coupled to the CO₂ purifier and configured to directly receive the purified CO₂ from the CO₂ purifier.

10. The system of claim 1, further comprising a controller configured to cause electrical energy to be applied to the CO₂ electrolyzer to cause the cathode to electrochemically reduce the CO₂ to produce the carbon containing product.

11. The system of claim 10, wherein the controller is further configured to cause electrical energy to be applied to the CO₂ purifier to cause the CO₂ purifier to produce the purified CO₂.

12. A method of converting carbon oxide to a carbon-containing product comprising:
purifying CO₂ in a CO₂ purifier comprising an anode, a cathode, and a plurality of parallel liquid flow paths between the anode and the cathode, wherein the plurality of parallel liquid flow paths comprise: (a) a carbonate donating flow path bounded on its anode-facing side by an anion exchange membrane, and (b) a carbonate receiving flow path arranged adjacent to, and on the anode side of, said carbonate donating flow path, wherein the carbonate receiving flow path is bounded on its cathode-facing side by said anion exchange membrane, the purifying comprising:
receiving impure CO₂;
contacting the impure CO₂ with a first solution and producing carbonate and/or bicarbonate ions;
flowing the first solution through the carbonate donating flow path;
flowing a second solution that is more acidic than the first solution through the carbonate receiving flow path;
applying a potential between the anode and cathode and causing the carbonate and/or bicarbonate ions to pass from the carbonate donating flow path to the carbonate receiving flow path; and
obtaining purified CO₂ from the second solution; and
electrochemically reducing the purified CO₂, the electrochemically reducing comprising:
providing the purified CO₂ to a CO₂ electrolyzer, and
electrochemically reducing the purified CO₂ at a cathode of the CO₂ electrolyzer to produce a carbon containing product.

13. The method of claim 12, wherein the carbonate donating flow path is bounded on its cathode-facing side by a bipolar membrane.

14. The method of claim 12, wherein the carbonate receiving flow path is bounded on its anode-facing side by a bipolar membrane.

15. The method of claim 14, further comprising
flowing the first solution through a second carbonate donating flow path, wherein the second carbonate donating flow path is bounded on its cathode-facing side by the bipolar membrane and is bounded on its anode-facing side by a second anion exchange membrane; and
flowing the second solution through a second carbonate receiving flow path, wherein the second carbonate receiving flow path is arranged adjacent to, and on the anode side of, said second carbonate donating flow path, and wherein the second carbonate receiving flow path is bounded on its cathode-facing side by said second anion exchange membrane.

16. The method of claim 15, wherein the second carbonate receiving flow path is bounded on its anode-facing side by a second bipolar membrane.

17. The method of claim 12, further comprising supplying the first solution from a first solution tank to the carbonate donating flow path; and recycling the first solution from the carbonate donating flow path to the first solution tank.

18. The method of claim 12, further comprising supplying the second solution from a second solution tank to the carbonate receiving flow path; and recycling the second solution from the carbonate receiving flow path to the second solution tank.

19. The method of claim 12, further comprising:
flowing a cation-donating solution through a cation-donating flow path to transport cations to the first solution, wherein the cation-donating flow path is adjacent to the anode and bounded on its cathode-facing side by a first cation exchange membrane; and
flowing a cation-receiving solution through a cation-receiving flow path to receive cations from the first solution, wherein the cation-receiving flow path is adjacent to the cathode and bounded on its anode-facing side by a second cation exchange membrane.

20. The method of claim 12, further comprising directly transporting the purified CO₂ from the CO₂ purifier to an inlet of the CO₂ electrolyzer.
